(19) United States
(12) Patent Application Publication
(10) Pub. No.: US 2014/0250355 A1
(43) Pub. Date: Sep. 4, 2014

(54) TIME-SYNCHRONIZED, TALKING EBOOKS AND READERS

(71) Applicant: The Cutting Corporation, Bethesda, MD (US)

(72) Inventors: David Michael Jimison, Brooklyn, NY (US); Jeffrey R. Crouse, Brooklyn, NY (US); Jacob Milam, Brooklyn, NY (US); William Van Dusen Wishard, JR., Bethesda, MD (US)

(73) Assignee: The Cutting Corporation, Bethesda, MD (US)

(21) Appl. No.: 14/196,682

(22) Filed: Mar. 4, 2014

Related U.S. Application Data
(60) Provisional application No. 61/784,849, filed on Mar. 14, 2013.
(60) Provisional application No. 61/772,481, filed on Mar. 4, 2013.

(51) Int. Cl. G06F 3/0483; G06F 17/30; G06F 17/21

(52) U.S. Cl. CPC G06F 3/0483; G06F 17/218; G06F 17/30044
USPC 715/202

(57) ABSTRACT

A eBook generation system generates a time-synchronized, talking electronic book (“eBook”). The system uses searchable digital text of a work of authorship and corresponding marker data to generate eBook text data. Using an audio narration recording of the work and the generated eBook text data, the system generates synchronized text-to-audio metadata that associates a plurality of components of the eBook text data with time the components present in the audio narration recording. Furthermore, the system uses generated synchronized text-to-audio metadata and bibliographic metadata associated with the work to generate navigation control data that is capable of being used by an eBook reading device for navigational control of the display of eBook text data and playing of the audio narration recording.

### CROSS-REFERENCE TO RELATED APPLICATIONS

This application claims the benefit of priority under 35 U.S.C. 119(e) of U.S. Provisional Patent Application No. 61/772,481, entitled “TIME-SYNCHRONIZED, TALKING EBOOKS AND READERS,” filed on Mar. 4, 2013, and U.S. Provisional Patent Application No. 61/784,849, entitled “TIME-SYNCHRONIZED, TALKING EBOOKS AND READERS,” filed on Mar. 14, 2013, the entire disclosures of which are incorporated herein by reference in their entireties.

### FIELD

This disclosure relates to electronic books and more specifically to a system and a method directed to generating time synchronized, talking electronic books.

### BACKGROUND

Conventional audiobooks for visually impaired, blind, or dyslexic individuals allow a user to listen and navigate throughout the book. Such audiobooks are intended to be audio substitutes for the printed material and allow the individual to navigate text using audio recordings. Conventionally, the creation of such an audiobook was an expensive and time consuming effort requiring a sound engineer to manually add text-based markers to an audio recording of the book using, for example, sound editing software such as Sound Forge by Sony. The markers identified a characteristic of the book (e.g., the title, a chapter header, a sentence, a quote, a verse, etc.) This laborious process required the engineer to: (1) listen to the audio recording while following along with the text; (2) stop the audio recording when a marker needed to be added to the audio file; (3) adjust/navigate the audio recording to pinpoint the precise audio location for the marker; and (4) repeat steps (1)-(3) for all markers associated with the book. Because most books have thousands of markers, marking an audio recording using the conventional approach could consume hours, if not days of manual time by a sound engineer.

Next in the conventional process for creation of an audio book, the sound editing software outputs the name and time-stamped location of these markers in a file (e.g., a text or XML file) that associates each marker with a unique time in the audio recording. For example, each chapter is identified by the relative time in the audio recording where the narrator reached such chapter in the narration. From the output file an audio book is created where the markers provide navigation control or instructions to the media player, thus allowing a visually impaired, blind, or dyslexic individual to listen and navigate a book.

Since the advent of audio books, electronic books (i.e., eBooks) have increasingly become more favorable to traditional audio books and paper books, especially for non-visually impaired individuals. A need therefore exists to combine the benefits of a conventional audiobook with the visual experience offered by eBooks in a manner where audio is synchronized to the text of the book displayed in the eBook, and where a user can navigate the book by both the text and the audio so that visually impaired users can experience the benefits of an eBook while not sacrificing any of the advantages traditional audiobooks offered such individuals. A need also exists to improve or avoid the laborious process through which audio is synchronized to text.

### SUMMARY

A computer-implemented method is disclosed that generates a time-synchronized, talking electronic book (“eBook”). The method includes generating, using the computer, eBook text data for a work of authorship based on searchable digital text of the work and marker data, wherein the marker data identifies at least a characteristic of the work. Moreover, the method includes generating, using the computer, synchronized text-to-audio metadata based on the eBook text data and an audio narration recording of the work, wherein the synchronized text-to-audio metadata associates a plurality of components of the eBook text data with the time the components are present in the audio narration recording. Furthermore, the method includes generating, using the computer, navigation control data based on synchronized text-to-audio metadata and bibliographic metadata associated with the work, wherein the navigation control data is capable of being used by an eBook reading device for navigational control of the display of eBook text data and playing of the audio narration recording.

### BRIEF DESCRIPTIONS OF THE DRAWINGS

FIG. 1 illustrates a high level system overview for a time-synchronization talking eBook generation system;

FIG. 2 illustrates a block diagram of a time-synchronization talking eBook generation logic;

FIG. 3 illustrates detailed view of a time-synchronization talking eBook generation logic;

FIG. 4 illustrates a block diagram of a searchable digital text converter;

FIG. 5 illustrates a method for generating time-synchronization talking eBook data;

FIGS. 6-10 illustrate screen shots of a graphical user interface that allows a user to determine input files for generating a time-synchronization talking eBook;

FIGS. 11 and 12 illustrate an exemplary open package format (OFP) file;

FIGS. 13 and 14 illustrate screen shots of a graphical user interface that allows a user to determine input files for generating a time-synchronization talking eBook;

FIGS. 15-27 illustrate screen shots of a graphical user interface that allows a user to place markers in generating a time-synchronization talking eBook;

FIGS. 28A-C illustrate an exemplary synchronized text-audio metadata file;

FIG. 29 illustrates a screen shot of a graphical user interface that allows a user to determine input files for generating a time-synchronization talking eBook

FIGS. 30-33 illustrate a screen shot of a graphical user interface that allows a user to determine missing markers;

FIGS. 34A-D illustrate an exemplary navigation control data file;

FIG. 35 illustrates a flow diagram for adding marker data to an existing eBook;

FIGS. 36-40 illustrate a screen shot of a graphical user interface that allows a user to determine edit markers within an existing eBook;

FIG. 41 illustrates a high level diagram of an exemplary eBook reader;

FIG. 42 illustrates a detailed view of an exemplary eBook reader;

FIG. 43 illustrates an example screen shot of a title page of an exemplary eBook reader;

FIG. 44 illustrates an example screen shot of a selection page of an exemplary eBook reader;

FIG. 45 illustrates a flow diagram and layout diagrams for determining the display of text;

FIGS. 46-68 illustrate example screen shots for navigation control of playing an eBook; and

FIG. 69 illustrates a flow diagram and layout diagrams for determining the playing of audio.

### DETAILED DESCRIPTION

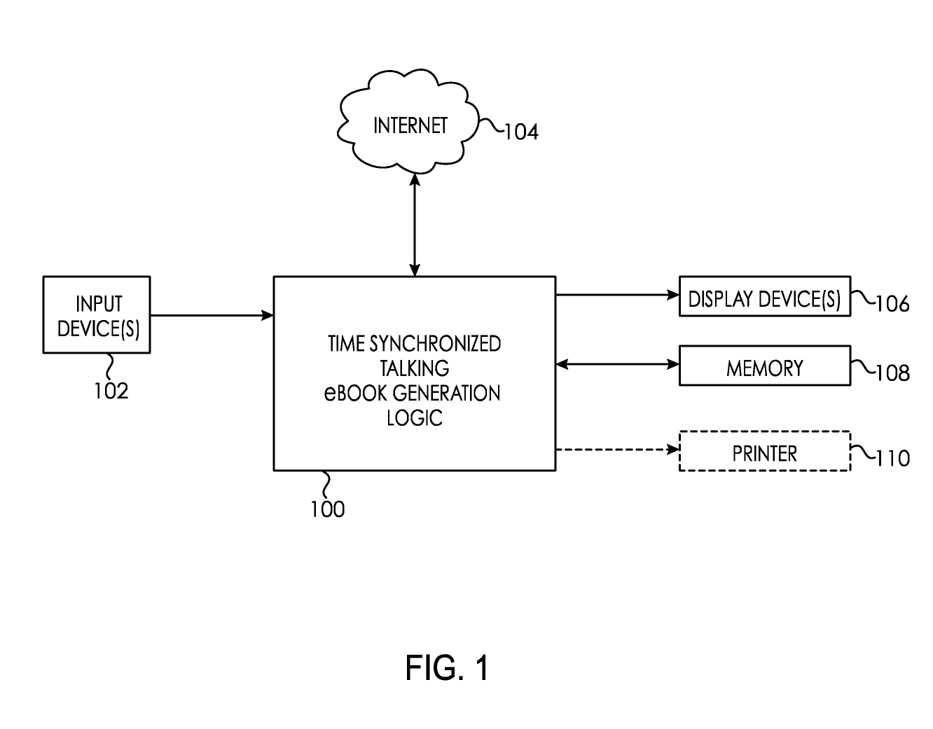

FIG. 1 illustrates a block diagram of an exemplary system for preparing or making a time-synchronized, talking electronic book (“eBook”) in accordance with one embodiment to the current disclosure. Exemplary system of FIG. 1 includes time-synchronized, talking eBook generation logic 100 in operable communication with one or more input devices 102, one or more display devices 106, memory 108, and optionally printer 110 and Internet 104. Each of the individual components of the system illustrated in FIG. 1 is coupled to each other via communication links, which are illustrated as arrows. Although depicted as a local system, the system of FIG. 1 may be a distributed system over a network (e.g., implemented over the Internet). Time-synchronized, talking eBook generation logic 100 may correspond to customized software stored in memory, for example, memory 108, associated with a computer or other suitable hardware.

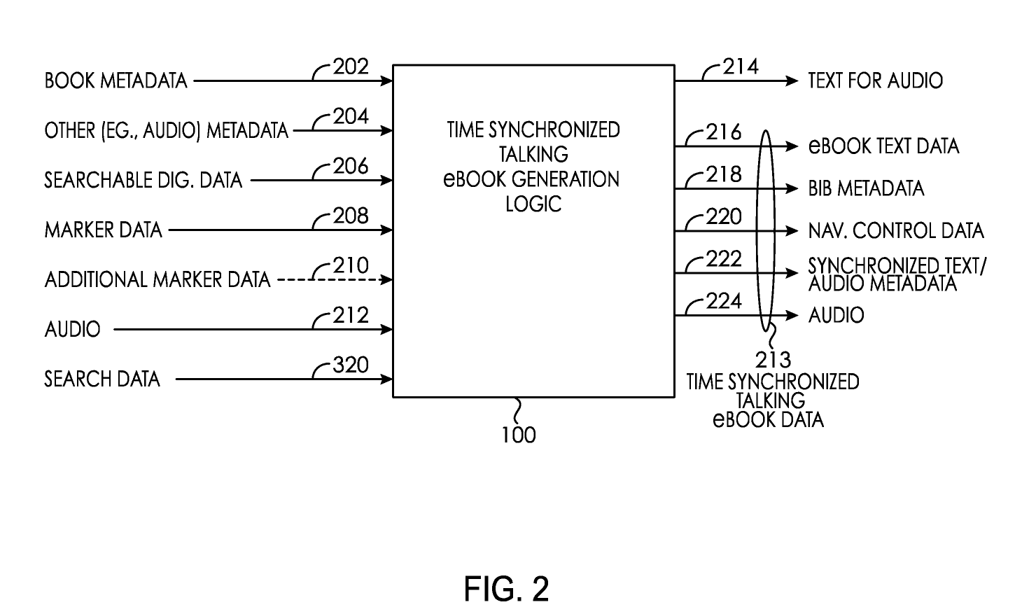

FIG. 2 illustrates a detailed block diagram of the time-synchronized, talking eBook generation logic 100 of FIG. 1. Time-synchronized, talking eBook generation logic 100 may include multiple inputs including but not limited to, book metadata 202, other metadata 204 (e.g., audio metadata), searchable digital data 206 (e.g., searchable digital text data, etc.), marker data 208, additional marker data 210, audio 212, and search data 320. Time-synchronized, talking eBook generation logic 100 may include multiple outputs such as text for audio 214 and time-synchronized talking eBook data 213, which may include eBook text data 216, bibliographic metadata 218, navigation control data 220, synchronized text/audio metadata 222, and audio 224.

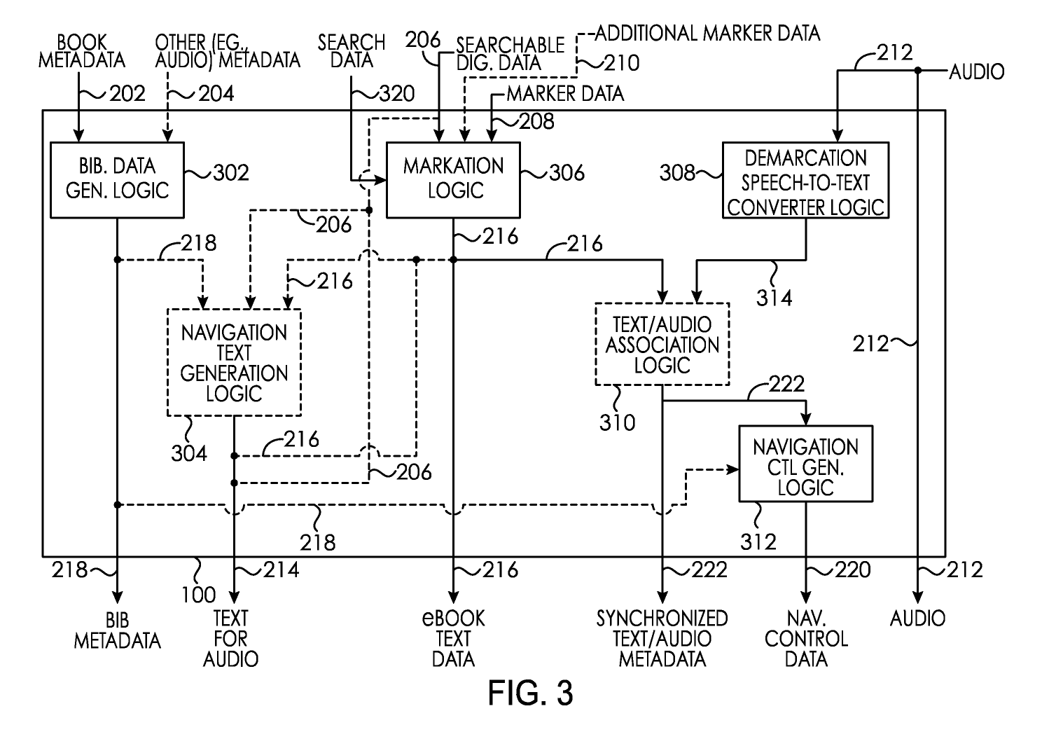

FIG. 3 illustrates a more detailed block diagram of the time-synchronized talking eBook generation logic 100 of FIGS. 1 and 2 and the inputs and outputs described generally with respect to FIG. 2. In particular, time-synchronized talking eBook generation logic 100 includes bibliographic graphic data generation logic 302, markation logic 306, demarcation speech-to-text converter logic 308, text/audio association logic 310, and navigation control generation logic 312. Time-synchronized talking eBook generation logic 100 may also optionally include navigation text generation logic 304.

Bibliographic data generation logic 302 generates bibliographic metadata 218 based on at least book metadata 202. In one embodiment, bibliographic data generation logic 302 may also generate bibliographic metadata 218 based on the combination of book metadata 202 and other (e.g., audio) metadata 204. The markation logic 306 generates eBook text data 216 based on searchable digital data 206 and marker data 208. Demarcation speech-to-text converter logic 308 generates time-stamped text data 314 based on audio 212. Text/audio association logic 310 generates synchronized text/audio metadata 222 based on eBook text data 216 and time-stamped text data 314. In one embodiment synchronized text/audio metadata 222 is further based on additional marker data 210. Additional marker data 210 may be book specific and could span across all books. For example, additional marker data 210 may include pricing information and information from a social network, such as highlights from friends. Navigation control generation logic 312 generates navigation control data 220 based on synchronized text audio metadata 222 and, optionally bibliographic metadata 218. In one embodiment, time-synchronized talking eBook generation logic 100 includes navigation text generation logic 304, which generates text for audio 214 based on one of searchable digital data 206 or eBook text data 216. Text for audio 214 may also be generated based on bibliographic metadata 218. When navigation text generation logic 304 is not included as part of time-stamped talking eBook generation logic 100, text for audio 214 is simply the searchable digital data 206 or eBook text data 216.

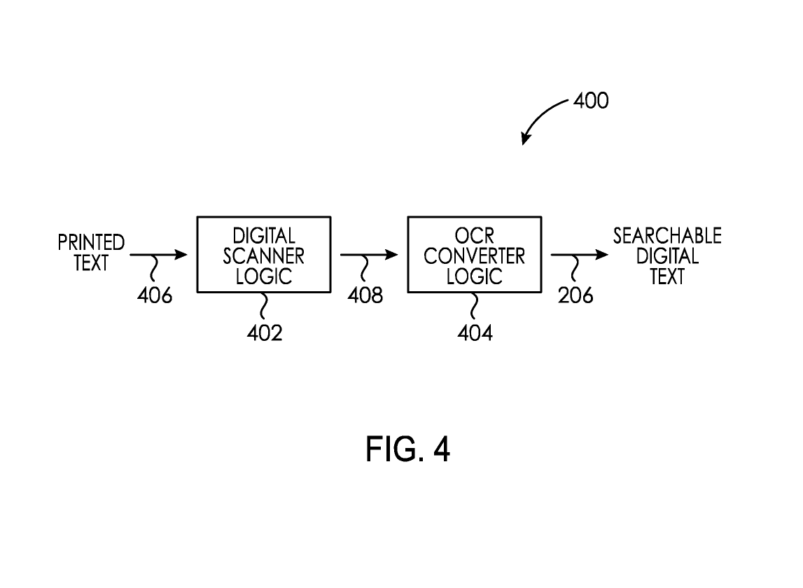

FIG. 4 illustrates a block diagram of a searchable digital text converter 400, which includes digital scanner logic 402 and optical character recognition (“OCR”) converter logic 404. Printed text 406 is input to digital scanner logic 402, which in turns generates scanned text 408. OCR converter logic 404 generates searchable digital text data 206 based on scanned text 408. Those of skill in the art will recognize that the digital scanner logic 402 may include a conventional digital scanner capable of generating, for example, a scanned image (e.g., a PDF) of the text. OCR converter logic 404 may include any logic capable of converting the scanned image into machine encoded text so that the text can be searched by a computer.

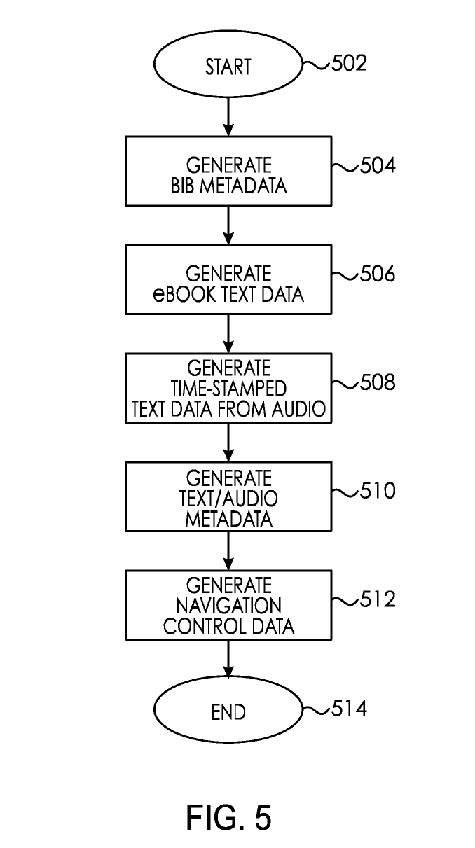

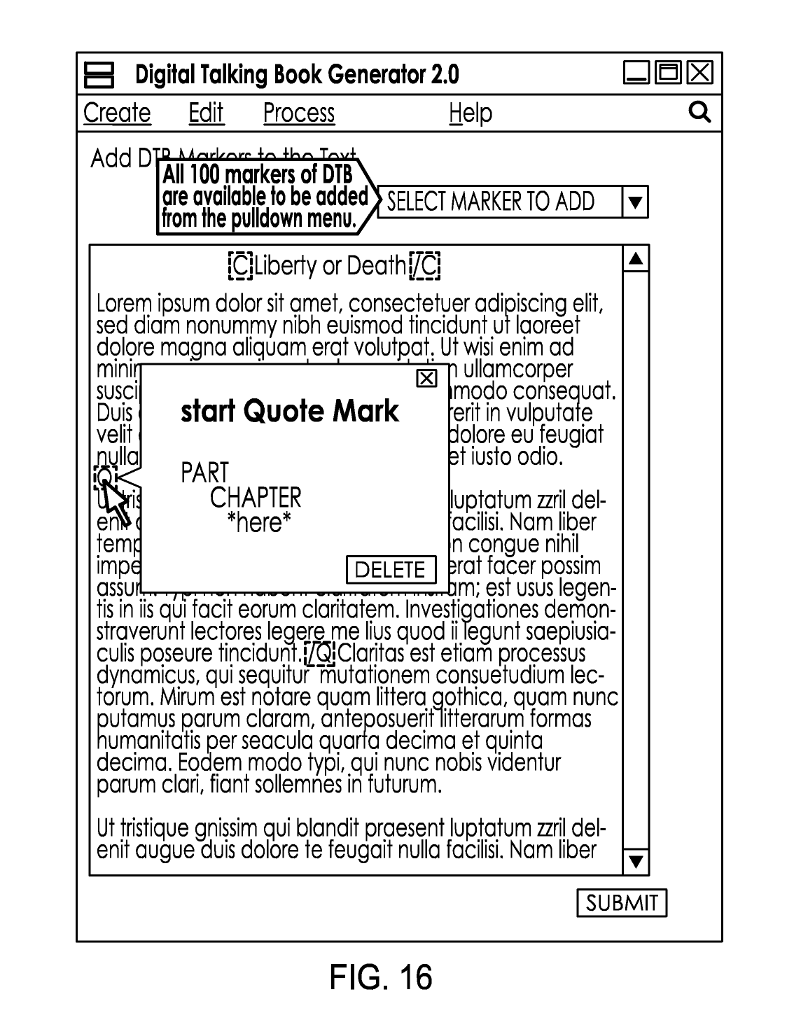

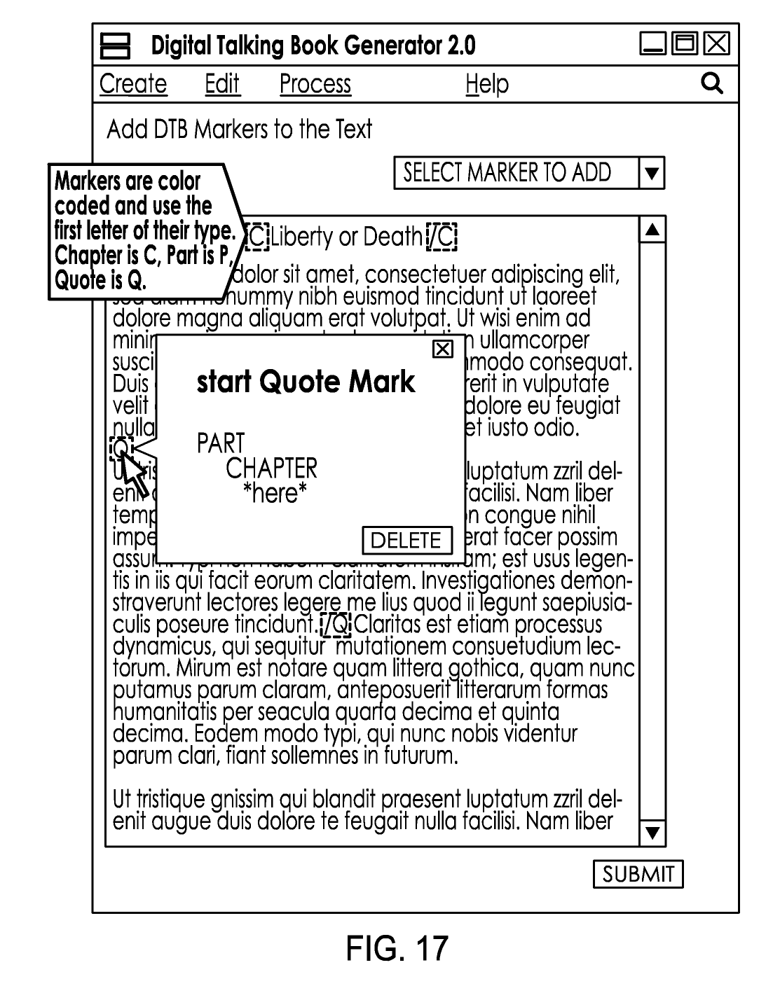

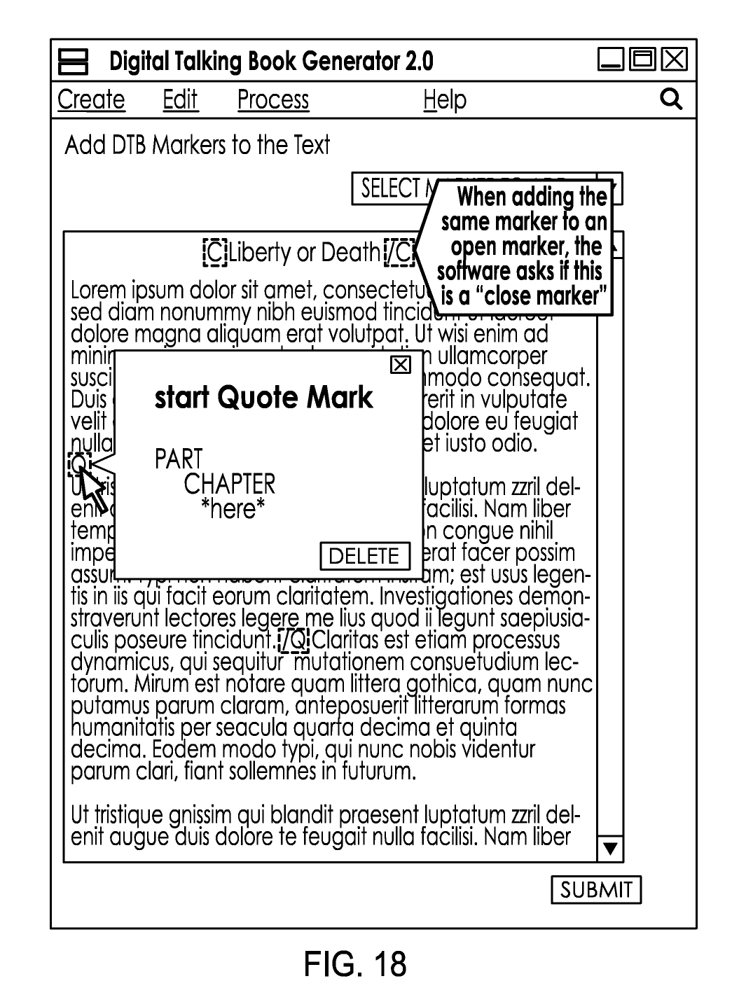

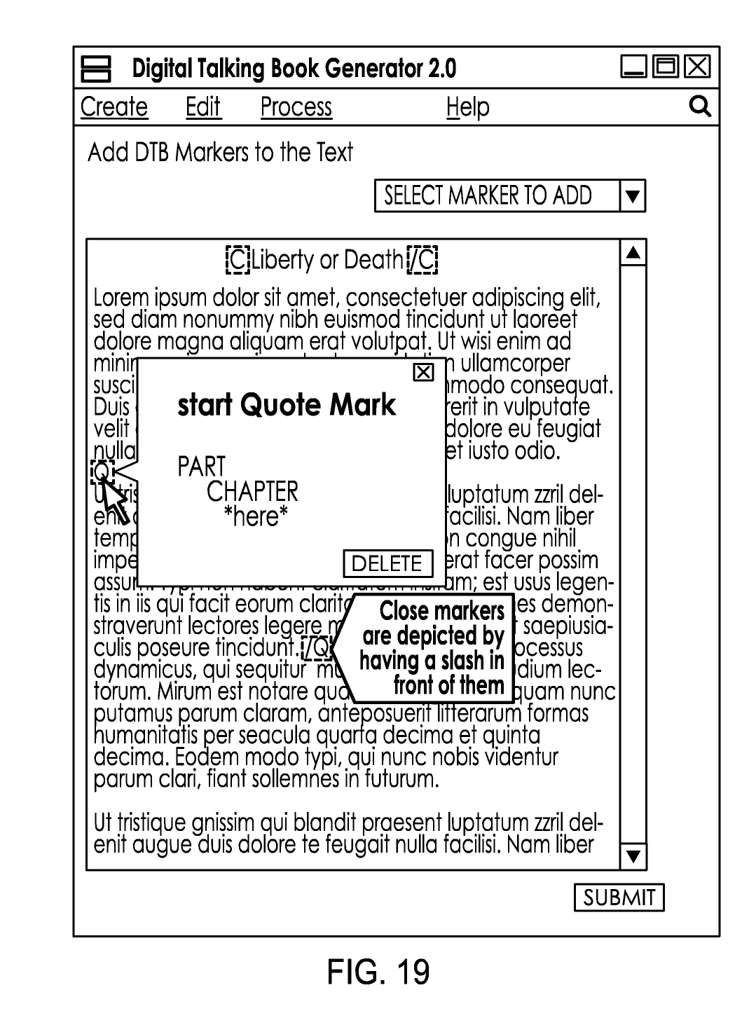

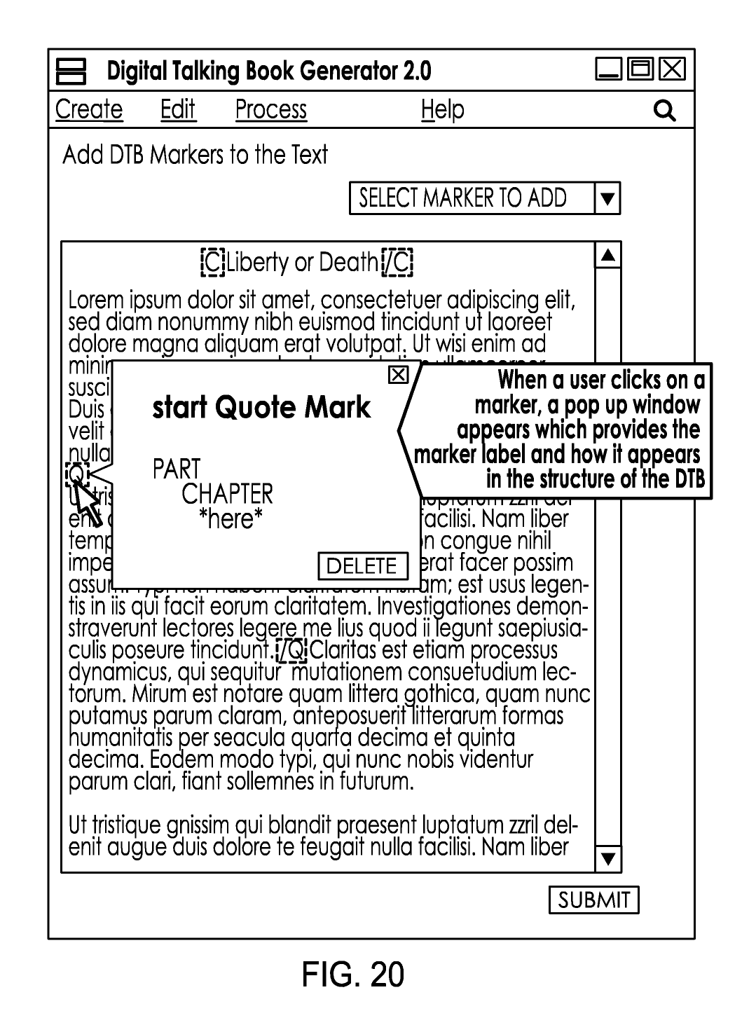

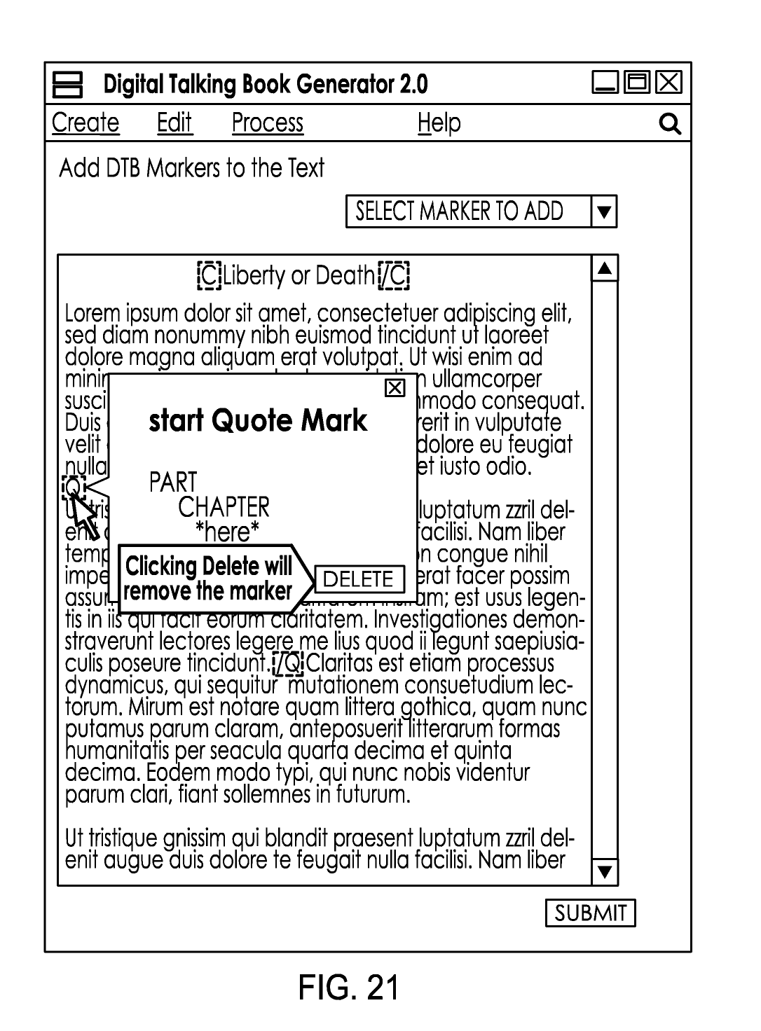

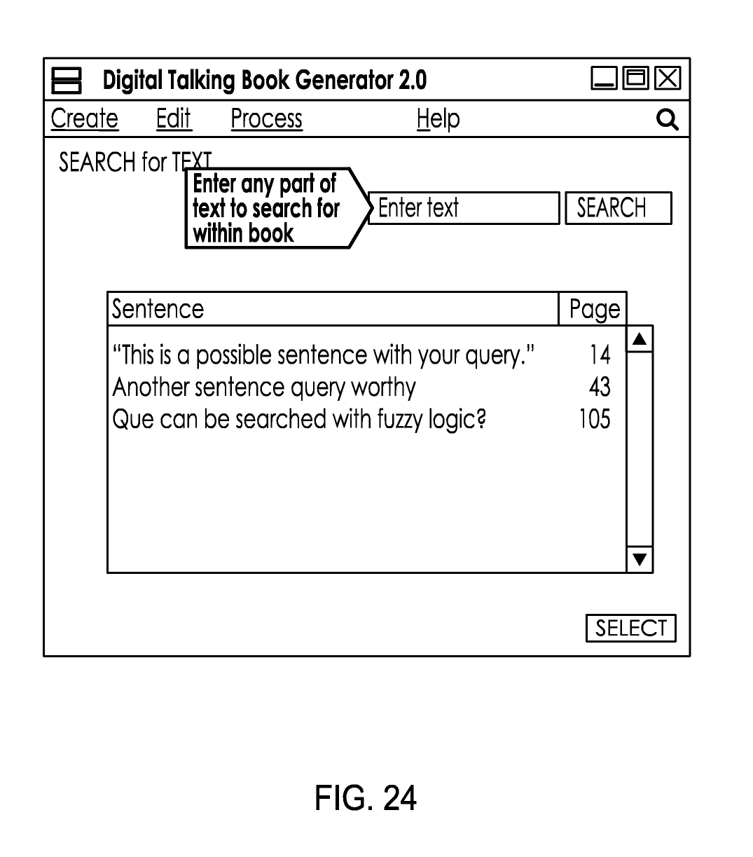

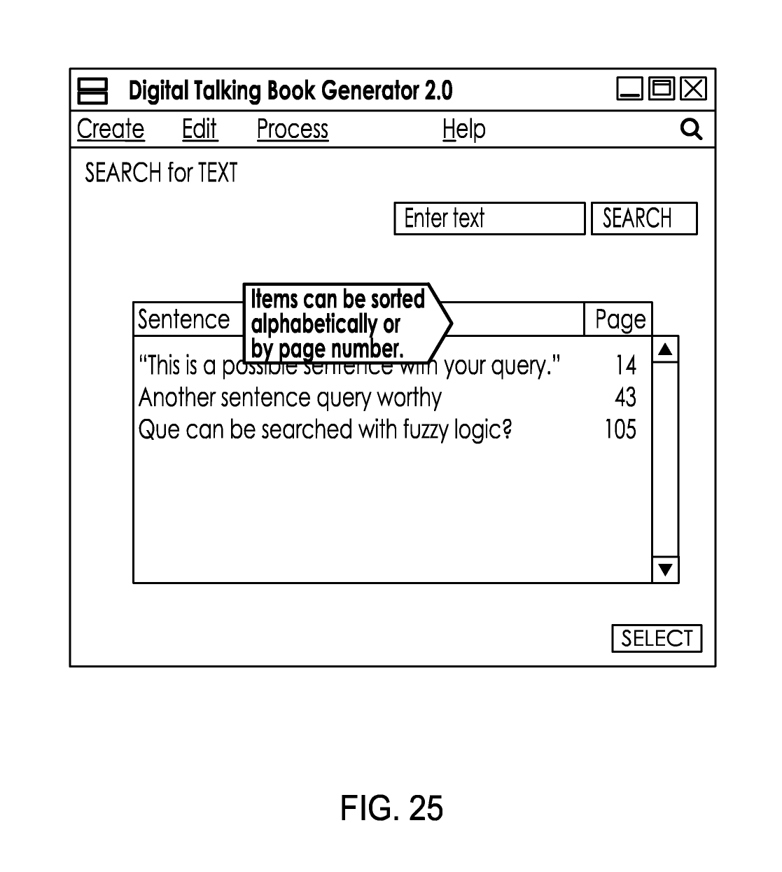

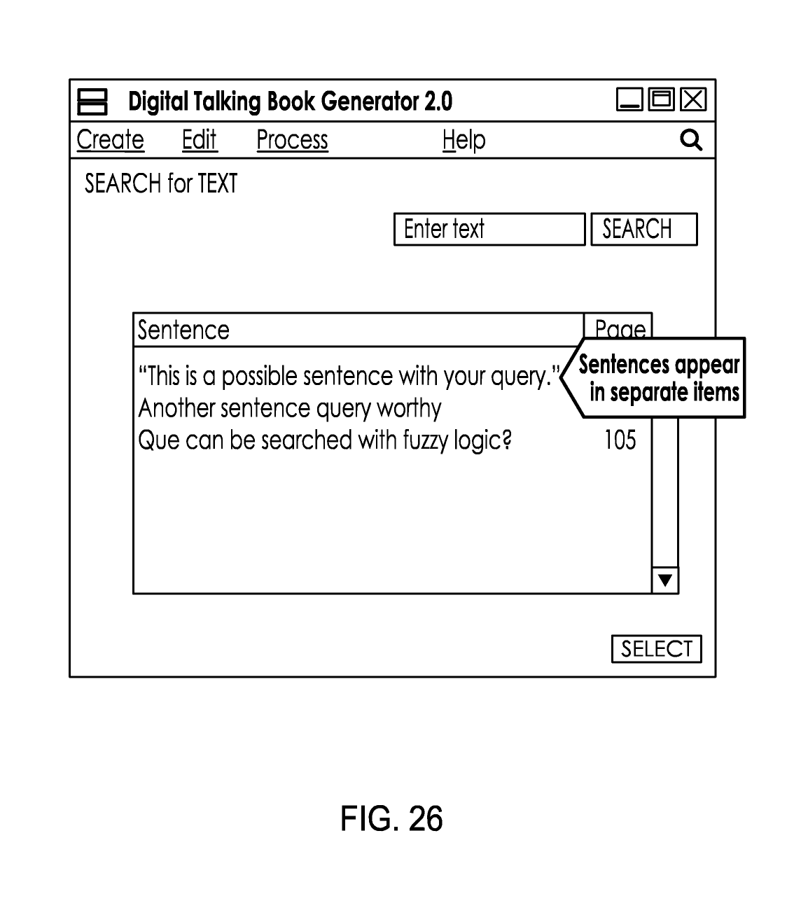

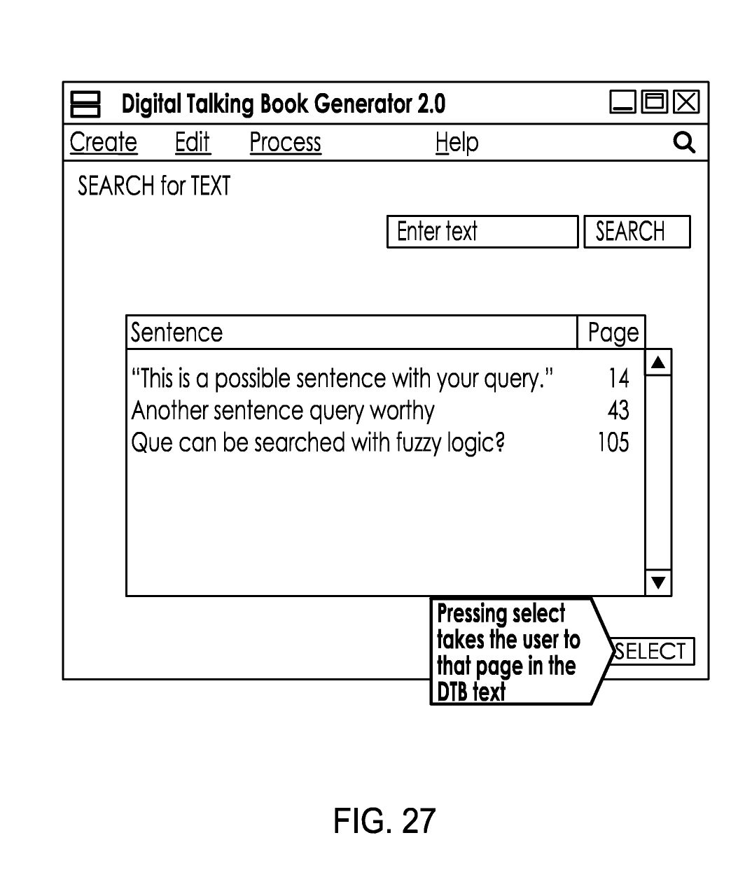

FIG. 5 is an exemplary flow chart describing the method in which the time-synchronized talking eBook generation logic 100 may be used to generate an eBook and associated time-synchronized talking eBook data 213. With reference to FIGS. 1-4 and 6-32, the method begins with block 502 where for example, a particular book or other work of authorship such as but not limited to magazine articles, magazines, periodicals, periodical articles, newspapers, newspaper articles, poems, abstracts, white papers, book reports, book reviews, etc. may be selected for the purpose of generating an eBook in accordance with the present disclosure.

Block 502 may also include the generation of searchable digital text data 206 corresponding to the selected work, if not already available. Searchable digital text data 206 may be generated in accordance with FIG. 4. Block 502 may also include obtaining book metadata 202 (as described below in more detail) corresponding to the searchable digital text data 206.

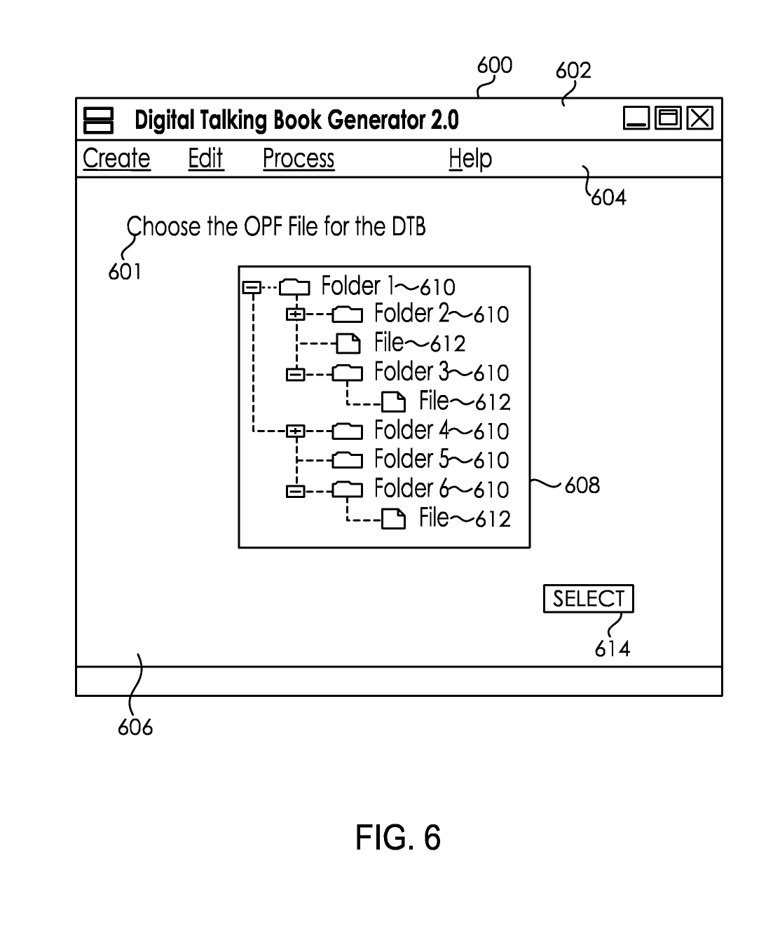

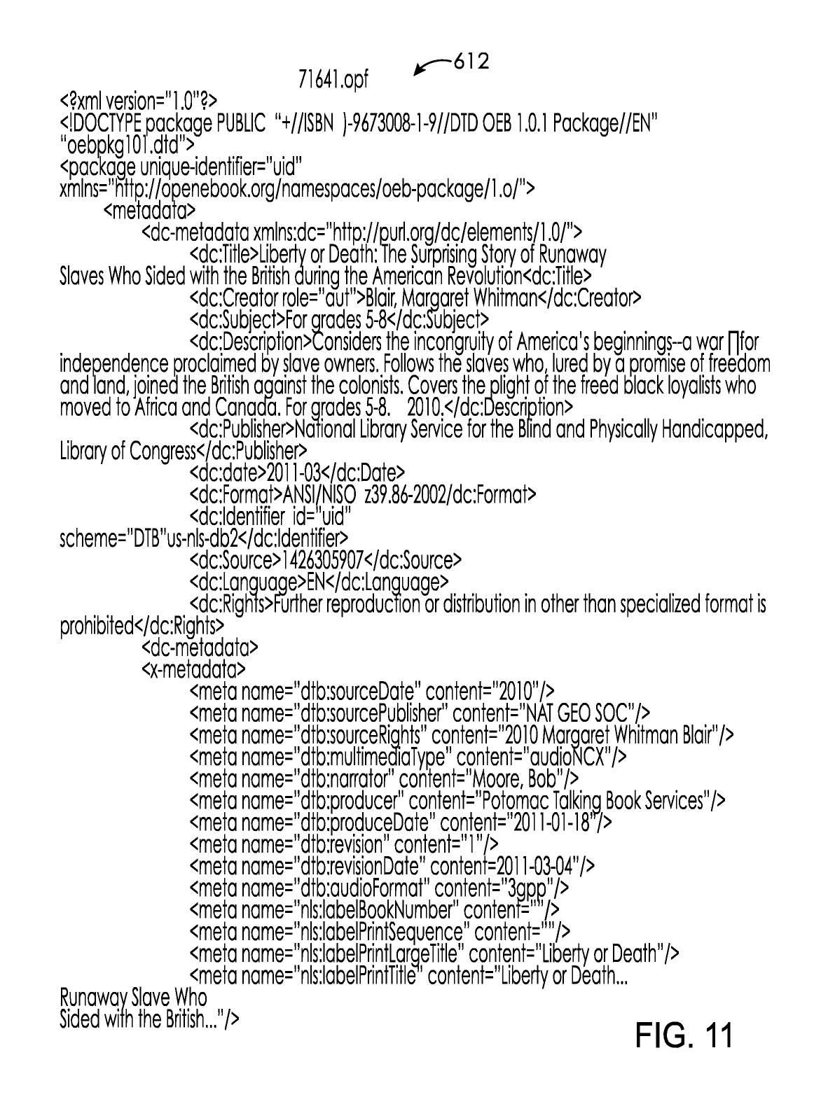

As illustrated in FIG. 4, the method continues with block 504 where bibliographic metadata 218 is generated. Bibliographic metadata 218 may be generated by the bibliographic metadata generation logic 302 as described above. With reference to FIGS. 6-12, bibliographic metadata 218 may be generated using a graphical user interface (“GUI”) 600 displayed on a display device such as display device 106. Exemplary GUI 600 of FIG. 6 permits the user of the time-synchronized talking eBook generation logic 100 to assist in the generation of bibliographic metadata 218. GUI 600 includes a title bar 602, a menu bar 604, and window body 606. Window body 606 may include a prompt 601 for instructing the user to choose an appropriate OPF (“open package format”) file for the creation of the time-synchronized talking eBook data. One of skill in the art may appreciate that the OPF file may be configured pursuant to the ePub standard, DAISY (“Digital Accessible Information System”) standard, or any other suitable standard. The current ePub standard (ePub 3.0) and overview attached hereto as Exhibit A are hereby incorporated by reference as if expressly set forth herein. The DAISY standard (recognized as ANSI/NISO Z39.86-2005 (R2012)) attached hereto as Exhibit B is hereby incorporated by reference as if expressly set forth herein. The DAISY standard is a technical standard for digital audio books. An exemplary OPF file is illustrated in FIGS. 11A-B.

Window body 606 may include a window 608 displaying a collection of OPF folders 610 and files 612 from which a user may navigate and select an appropriate OPF file corresponding to the printed text 406 (i.e., the book) of FIG. 4 for which the user desires to create an eBook and, as such, desires to obtain predetermined metadata stored as part of the OPF file. A user utilizes an input device 102 (as shown in FIG. 1) to select a particular file 612 and select the search select button 614.

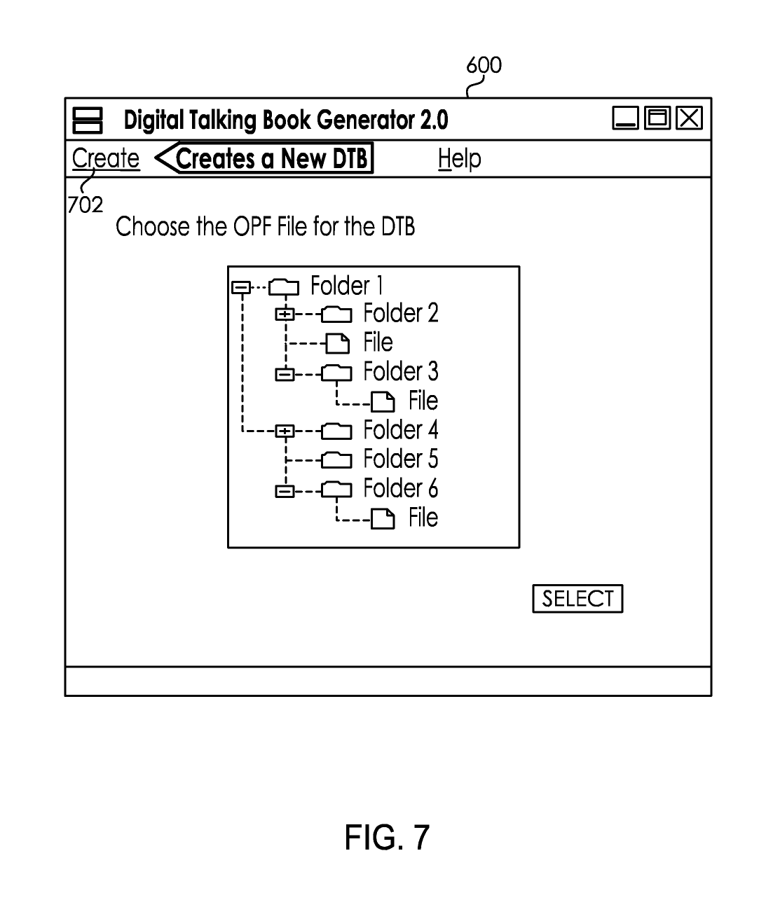

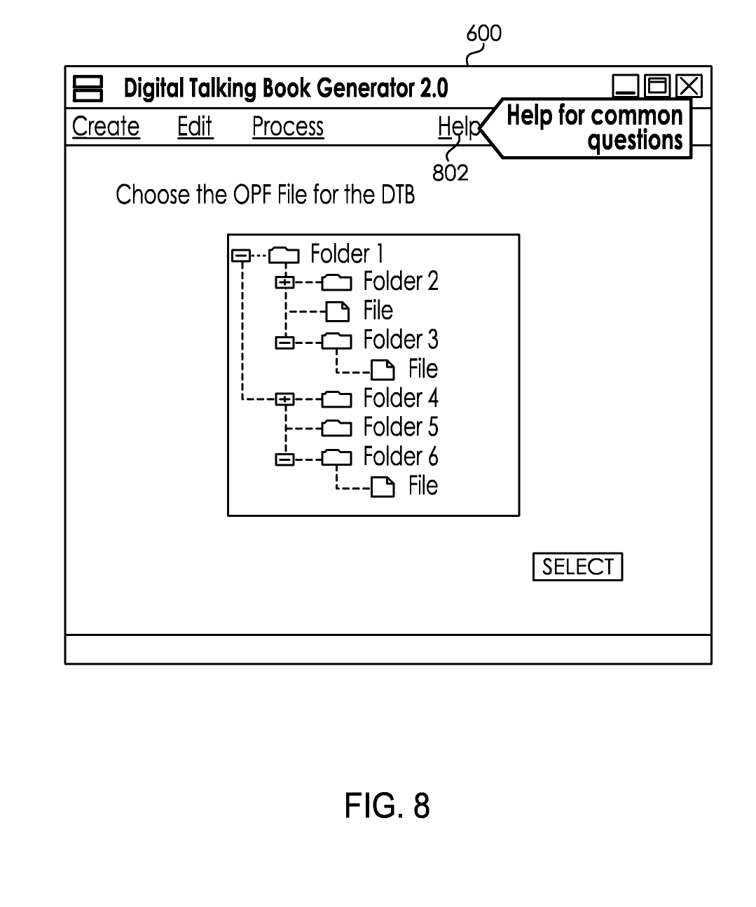

One of skill in the art will appreciate that the GUI 600 may include a variety of menu buttons in the menu bar 604. For example, as shown in FIG. 7, the create menu button 702 may allow a user to create a new DTB. In one embodiment, a user is required to select the create menu button 702 to initiate the display of the data illustrated in FIG. 6. Moreover, as illustrated in FIG. 8, the help menu button 802 may assist a user in determining the answer to frequently asked or common questions or may include the display of conventional help features or guides.

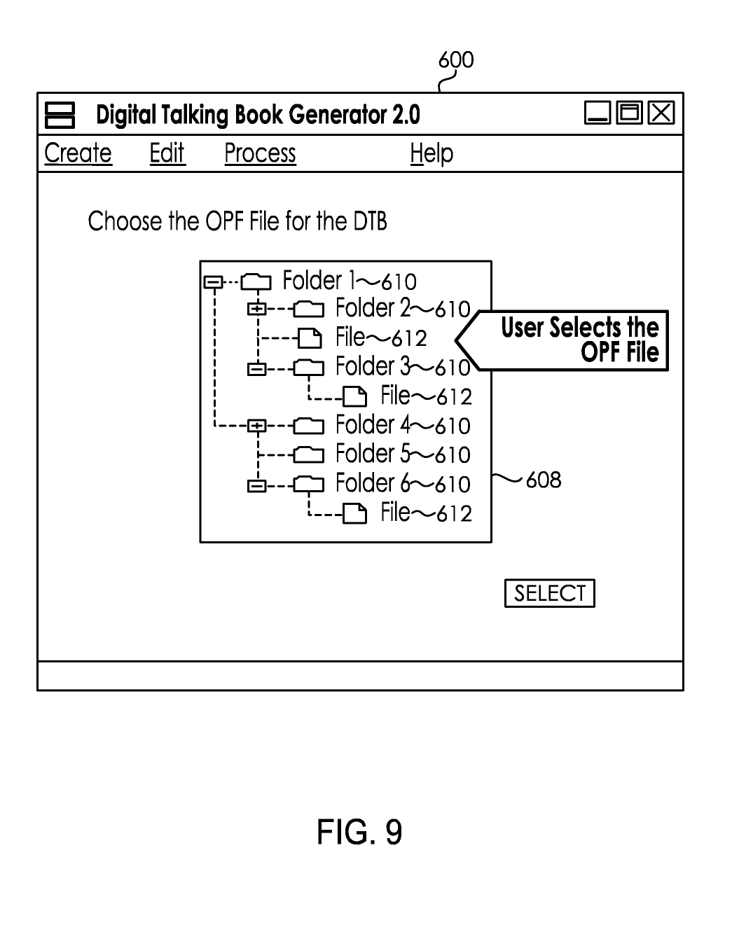

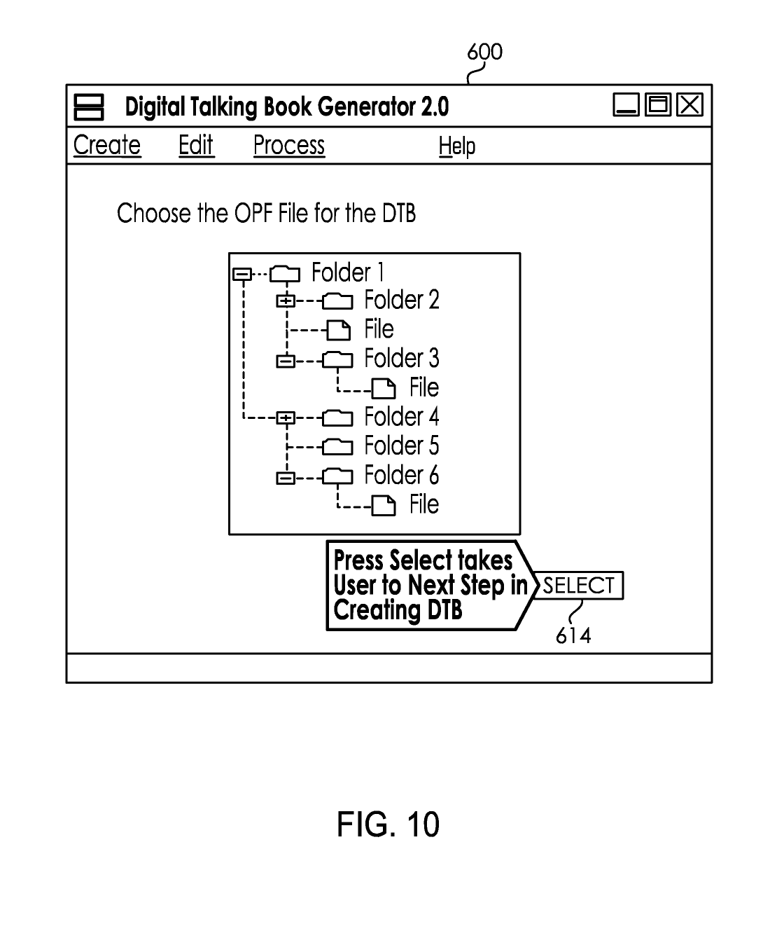

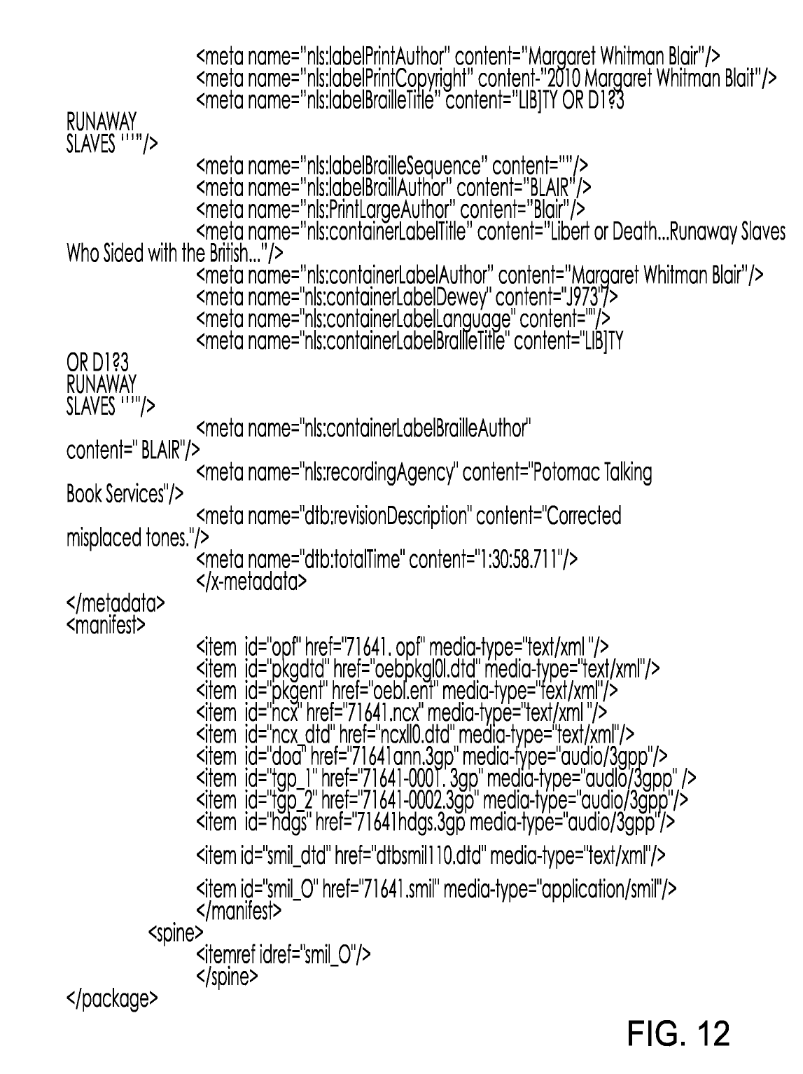

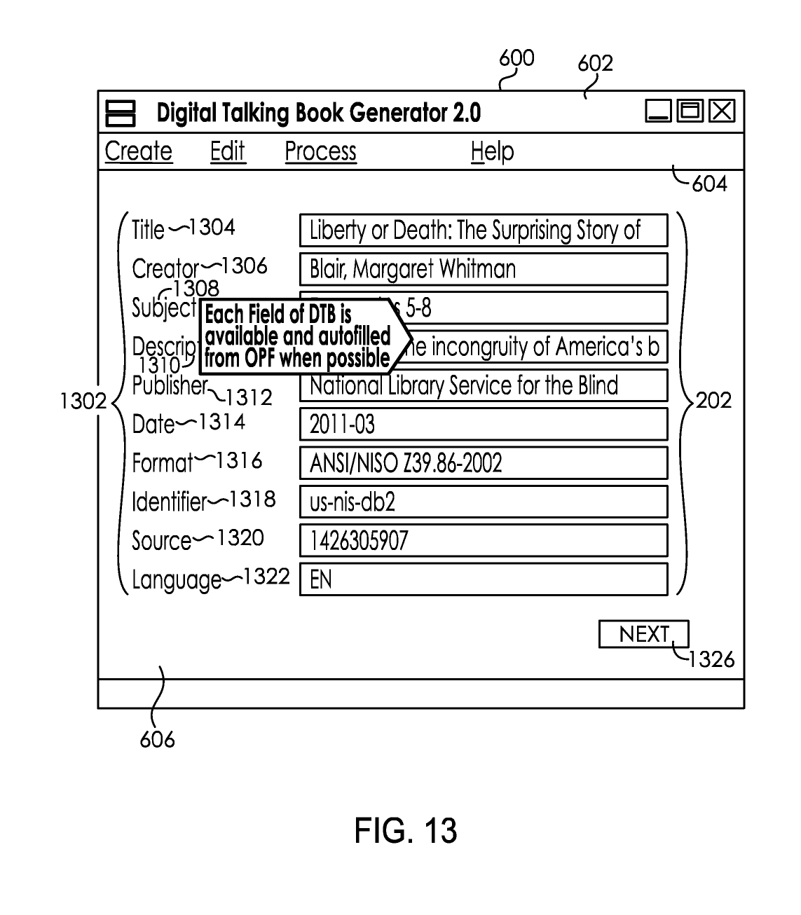

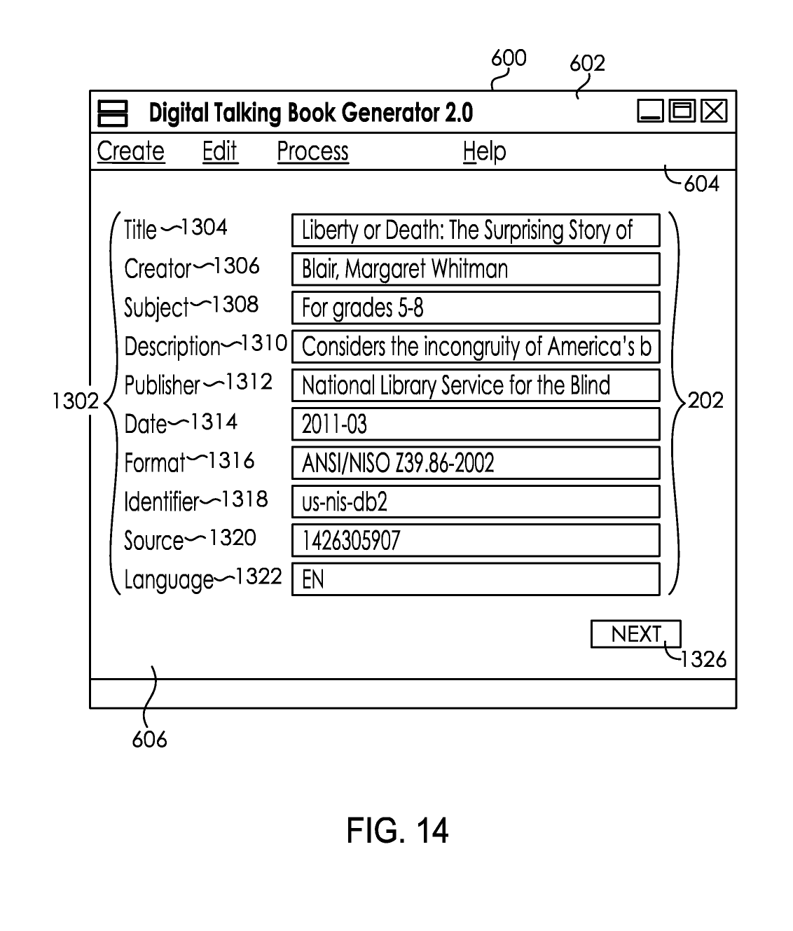

Upon selection of a particular OPF file 612 (as shown in FIGS. 9 and 10), predetermined book metadata 202 may be displayed as part of the window body 606 as illustrated in FIGS. 13 and 14. Book metadata 202 may include data associated with a variety of book metadata fields 1202. For example and with reference to FIGS. 13 and 14, book metadata fields 1302 may include title 1304, creator 1306, subject 1308, description 1310, publisher 1312, date 1314, format 1316, identifier 1318, source 1320, and language 1322. Fields 1302 are merely exemplary, and other fields and corresponding types of book metadata 202 may be included in addition or in the alternative. Preferably, OPF file 612 includes metadata 202 corresponding to book metadata fields 1302. For example, the exemplary OPF file, as shown in both FIGS. 11 and 12, includes metadata that is displayed in FIGS. 13 and 14 as book metadata 202 associated with fields 1302. After a user is finished viewing the book metadata fields 1302, the user continue the eBook generation process by selecting a “Next” selector icon 1326.

Preferably, the bibliographic data generation logic 302 is configured to populate the fields 1302 with book metadata 202 associated with the searchable digital text data 206 for display as part of window body 606 based on the OPF file 612. To the extent that the bibliographic data generation logic 302 is unable to read metadata from the OPF file 612, or alternatively, if the OPF file 612 does not contain metadata for each of the fields 1302, other metadata 206 may be supplied by the user through the GUI associated with FIGS. 13 and 14. For example, information associated with the narration of the audio associated with the final eBook may be supplied by a user. Collectively, bibliographic metadata 218 corresponds to the book metadata 202 and any additional other metadata 204 as generally described above and displayed in FIGS. 13 and 14.

Referring back to FIG. 5, the method continues in block 506 where eBook text data is generated. In one embodiment, eBook text data 216 may be generated by the markation logic 306, as shown in FIG. 3, based on searchable digital text data 206 and marker data 208 supplied by a user. Marker data 208 is any data that identifies a feature or characteristic of the work, and may include, for example, one or more of the following markers:
a) acknowledgments, act, activity, address, afterword, alphabetical division, annotation, appendices, appendix, article, author's note, biographical notes, biography, bibliography, book, captions, cast of characters, chapter, chronology, closing announcements, conclusion, contents, day, discography, dramatis personae, entry, epilogue, essay, exercise, fable, family tree, filmography, foreword, further reading, genealogy, glossary, illustrations, index, ingredients, introduction, lesson, letter, maps, materials, month notes, novelette, novella, part, photographs, poem, postscript, prayer, preface, prelude, project, prologue, proverb, psalm, questions, questions and answers, recipe, recommended reading, references, resources, scene, section, selected references, sources, song, sonnet, speech, stanza, steps, story, subsection, suggested reading, summary, supplement, supplies, synopsis, table of contents, tale, testament, time line, title/author, unit, verse, vocabulary, volume, week, year

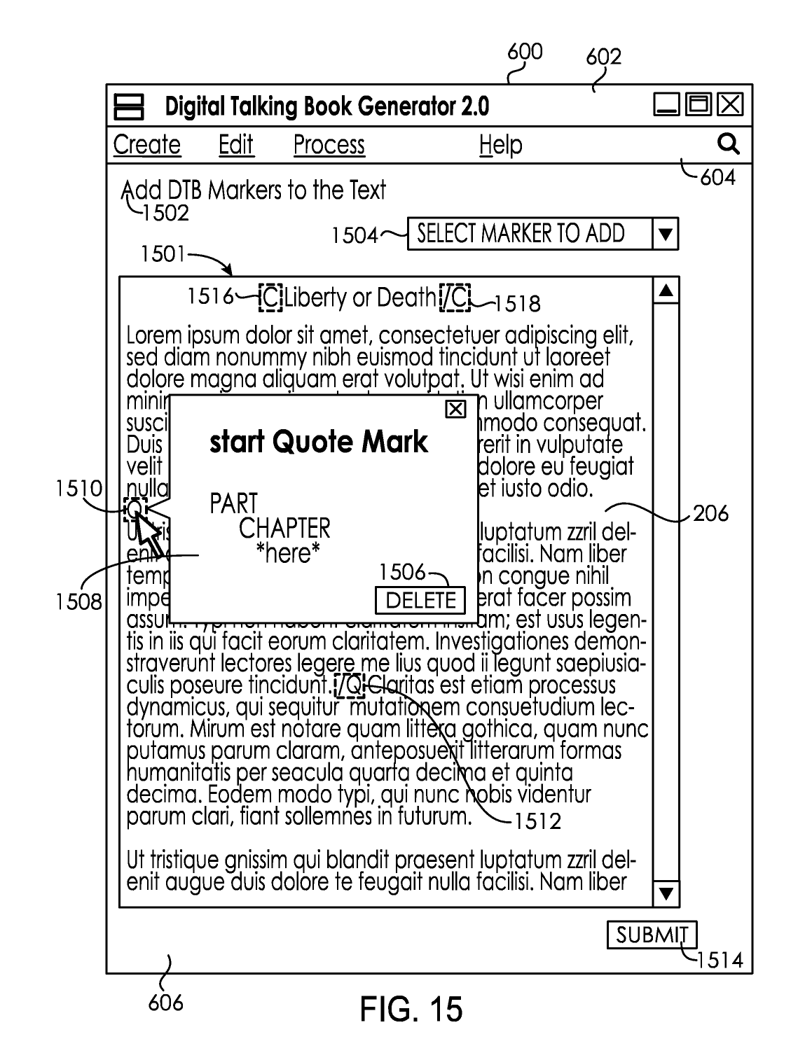

With reference to FIGS. 15-22, the markation logic 306 may utilize GUI 600 to mark the searchable digital text data 206 using marker data 208. Window 606 includes a text display window 1501 setting forth the searchable digital text data 206. The GUI 600 may include a prompt 1502 instructing the user to add marker data 208 to the text and a pull-down window 1504 in which a user may select a particular type of marker data 208 to add to the searchable digital text data 206 using an input device 102. As illustrated in FIGS. 15-22, the chapter title, “Liberty or Death” may be marked using an opening chapter marker 1516 and a closing chapter marker 1518. Similarly a quote may be marked using an opening quote marker 1510 and a closing quote marker 1512. In one embodiment, a window 1508 may be displayed by the markation logic 306 to assist the user in showing the use, placement and meaning of a particular marker.

In one embodiment markers and marker text are color coded and utilize the first letter of the marker type to identify the marker and the marked text. For example, chapter markers utilize “C,” part markers utilize “P,” and quote markers utilize “Q”. The actual markers are visually identifiable within the window 1501 as part of the searchable digital text data 206. Opening markers simply use the first letter of the marker type. Closing markers use a slash and the first letter of the marker type (e.g., “/C,” “/P”, and “/Q”). Markers appear in the window 1501 to show the user how markers will appear in the structure of the eBook or digital talking book. In one embodiment, the window 1508 may permit the user to delete marker data 208 using the delete button 1506. After a text has been appropriately marked, a user may select the submit button 1514 to submit the markations to the markation logic 306 for generation of eBook text data 216 comprising searchable digital text data 206 and marker data 208 associated therewith.

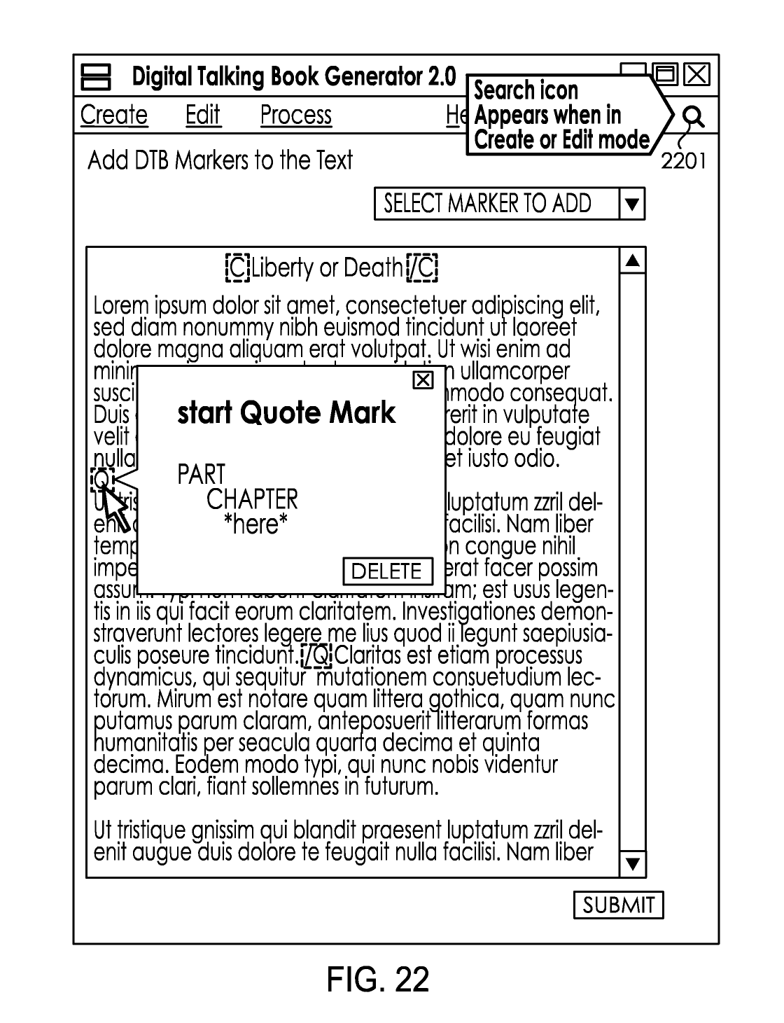

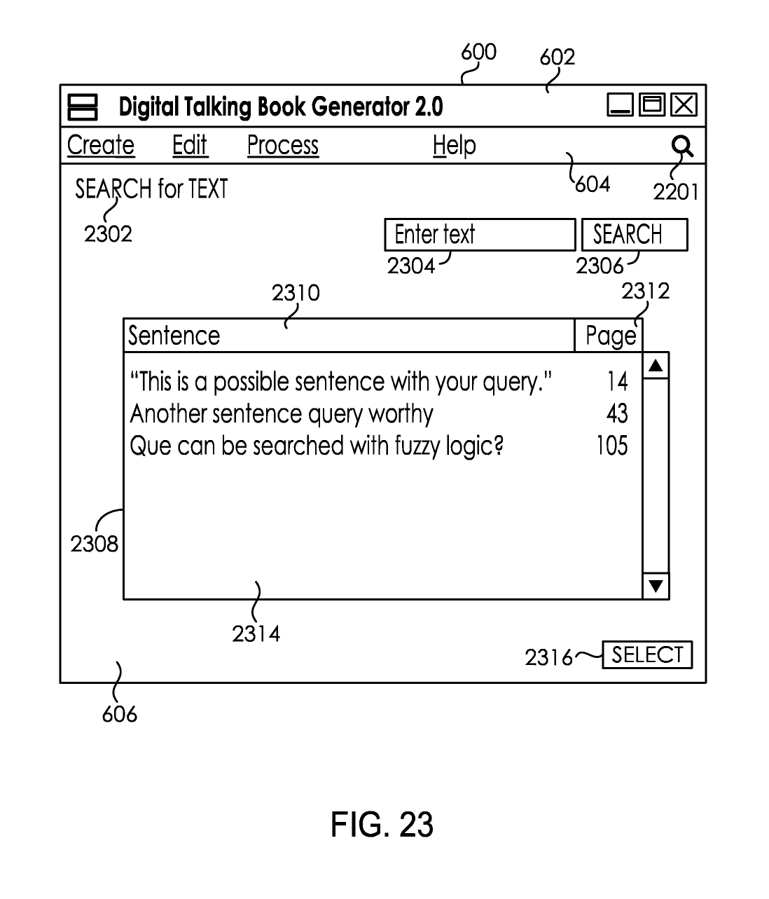

As shown in FIG. 5, block 506 may additionally include the utilization of a search window as illustrated in FIGS. 23-27 which permits a user to search for text to assist the user in marking the searchable digital text data 206 with marker data 208. Utilizing GUI 600, as shown in FIG. 22, the user may navigate to and select the search button 2201 in the menu bar 604, thereby generating the window 606 of FIG. 23. As illustrated in FIG. 23, prompt 2302 identifies window 606 as a search window and window 606 provides the user an opportunity to enter text in field or text box 2304 for searching text 206. By selecting the search button 2306 using for example an input device 102, display results 2314 are shown in display window 2308. Display window 2308 includes a sentence column 2310 and a page column 2312 to identify sentences in the searchable digital text data 206 that contain the searched-for text/criteria, and the page of the text 206 where the sentence appears. A user can select any entry within the display window 2308 and select the select button 2316 to be redirected to the page in the text where the sentence appears. For example, the user may be redirected to a window similar to the window shown in FIGS. 14-22. In one embodiment, the markation logic 306 is capable of performing the search and display functionality described above in response to search commands entered as search data 320.

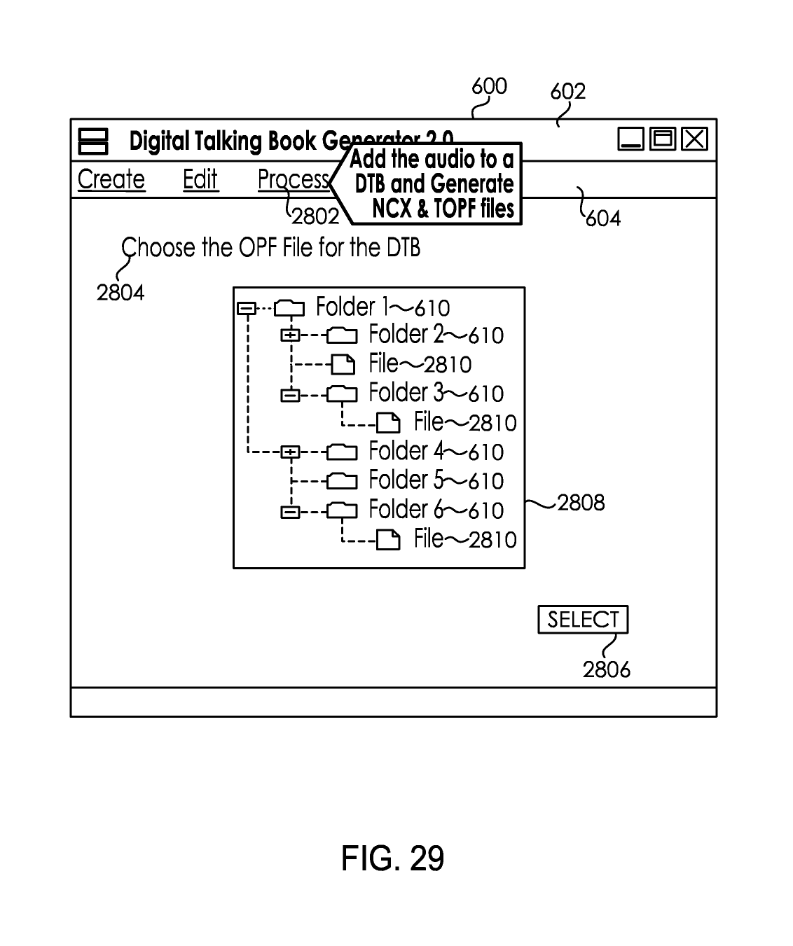

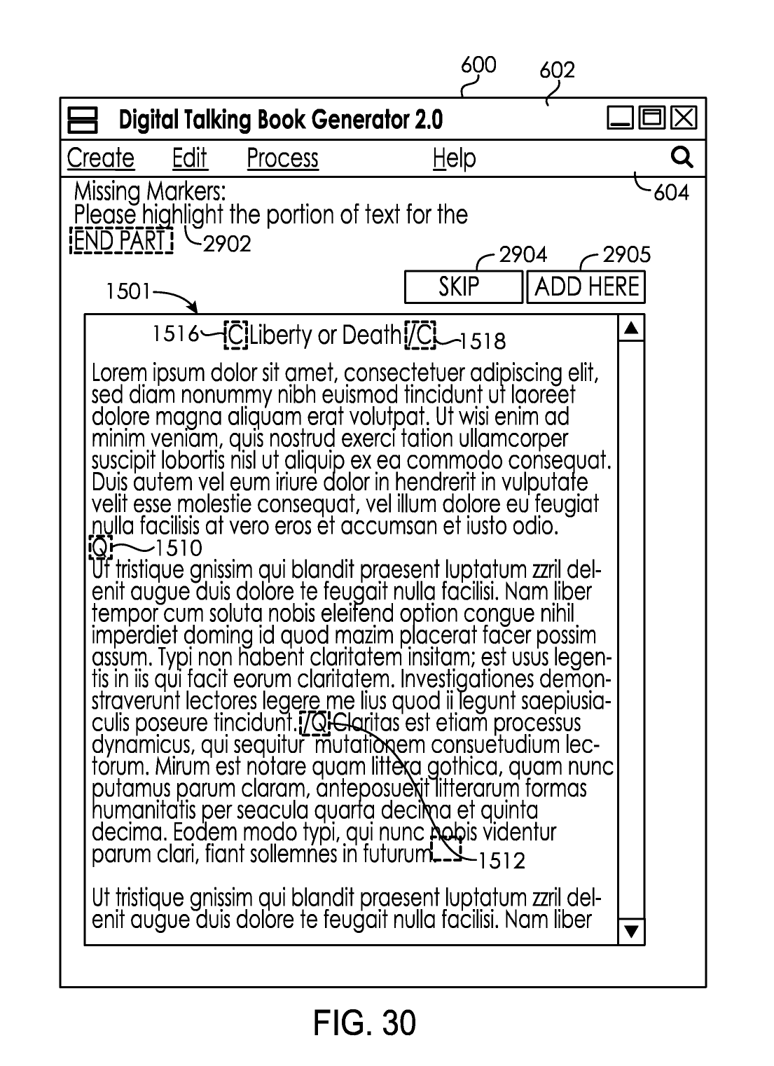

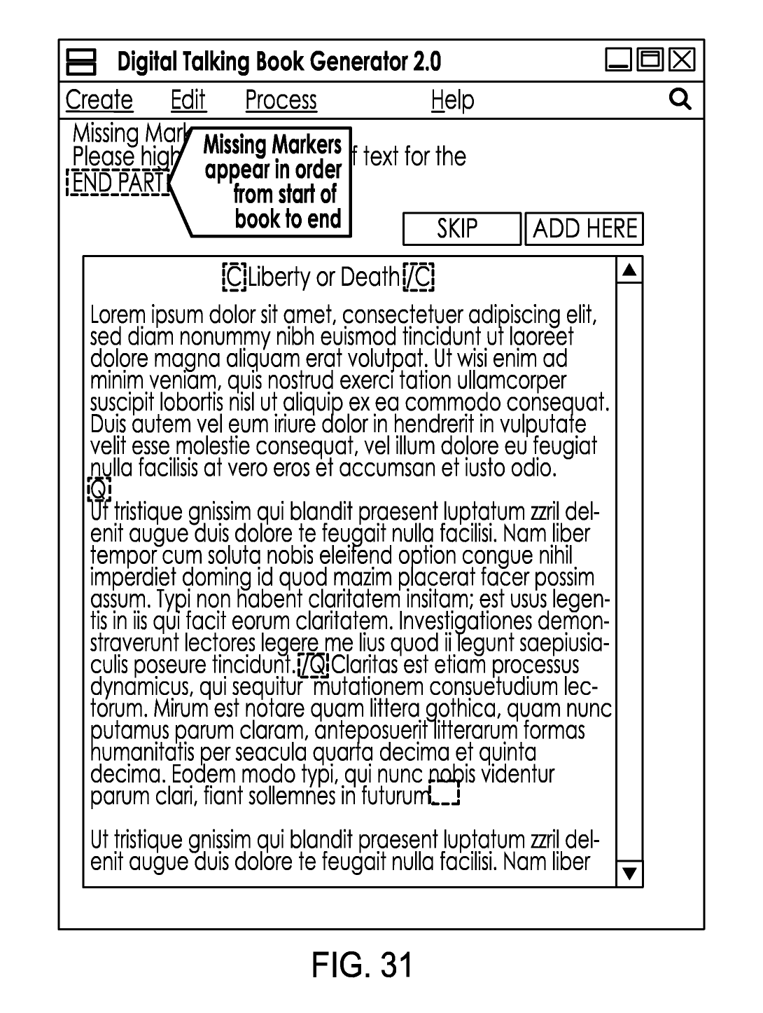

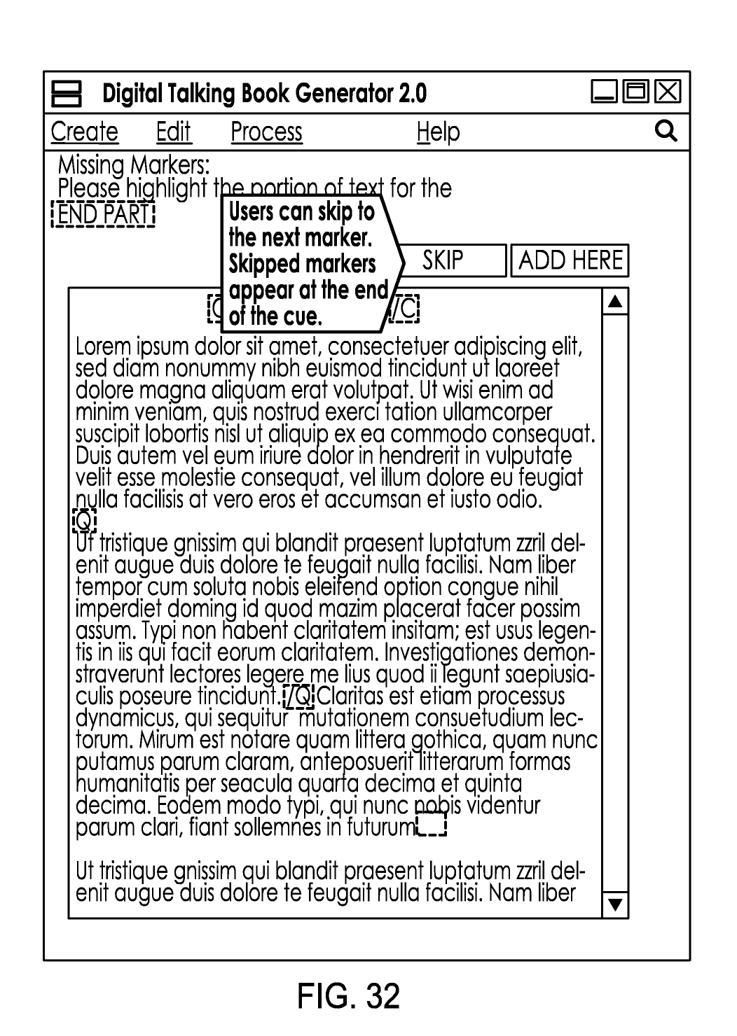

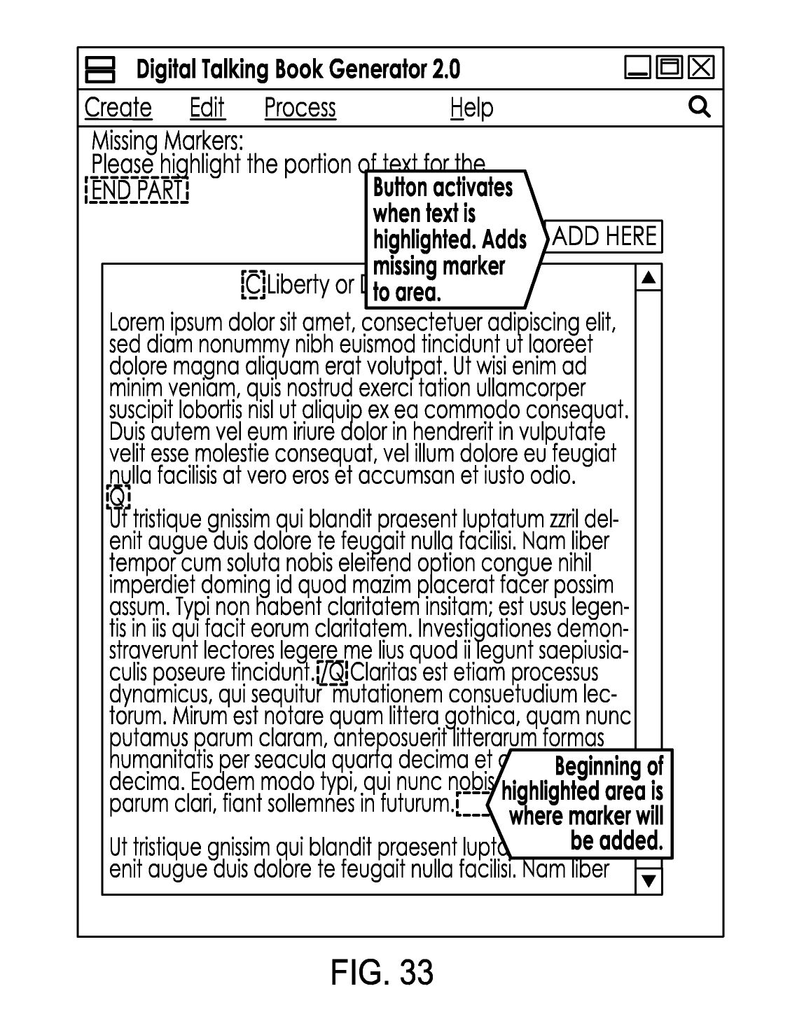

Referring again to FIG. 5, block 506 includes editing previously created eBook text 216. In such instances, the markation logic 306 may load a file 2810 having eBook text data 216 for processing as illustrated in FIG. 29. As shown in FIG. 29, prompt 2804 may instruct the user to select an OPF file for the DTB and selector 2802 may allow the user to add audio 212 in generating the DTB. Upon selection of the process menu 2302, as shown in FIG. 23, and choosing the OFP file having eBook text data 216 using window 2808 and the select button 2806 of FIG. 29, the markation logic 306 processes the file and generates display 1501, as illustrated in FIG. 30, that shows existing markers in the text. In one embodiment, the markation logic 306 identifies missing markers based on a comparison of existing markers in the text (as shown in FIG. 31.) In one embodiment, missing markers are all markers that are not present in the text that should be added. Opening markers are missing when there is an unmatched closing marker. Closing markers are missing when there is an unmatched opening marker. In another embodiment, missing markers are only those that are missing, as described above, and that are necessary to be compatible with the ePub and Digital Talking Book standards. Prompt 2902 of FIG. 30 prompts the user to place missing markers within the eBook text data 216. The user can also remove opening or closing markers, or add new markers. The user either skips the request to add a marker by selecting the skip button 2904 (as shown in FIG. 32) or places missing markers and selects the add button 2905 (as shown in FIG. 32.) In one embodiment, added markers are provided to the markation logic 306 as additional marker data 212.

Block 506 may also include the generation of text usable for narrating the audio portion of the time-synchronized talking eBook data 213. The narration text 214 may be generated utilizing the time-synchronized, talking eBook generation logic 100 by simply printing, storing, or displaying the searchable digital text data 206 and/or the eBook text data 216 or by including the combination of one of the searchable digital text data 206 and the eBook text data 216 with certain bibliographic data 218 suitable for being read as part of the audio 212 associated with the final time-synchronized, talking eBook data 213. In one embodiment, the time-synchronized, talking eBook generation logic 100 may utilize a navigation text generation logic 304 to suitably combine the bibliographic metadata 218, or portions thereof, with the searchable digital text data 206 or the eBook text data 216 for output as narration text for audio 214. Narration text for audio 214 is then recorded by a user to generate audio 212.

The method of FIG. 5 continues with block 508 where time-stamped text data is generated from audio. With reference to FIG. 3, block 508 may be accomplished utilizing a demarcation speech-to-text converter logic 308, which generates time-stamped text data 314 based on the audio 212. Converter logic 308 may utilize conventional software or other algorithms such as the Dragon NaturallySpeaking™ audio transcription software commercially sold by Nuance Communications®. Time-stamped text data 314 comprises a transcription of the audio 214 as text along with a time stamp associated with each component (e.g., word) of the text.

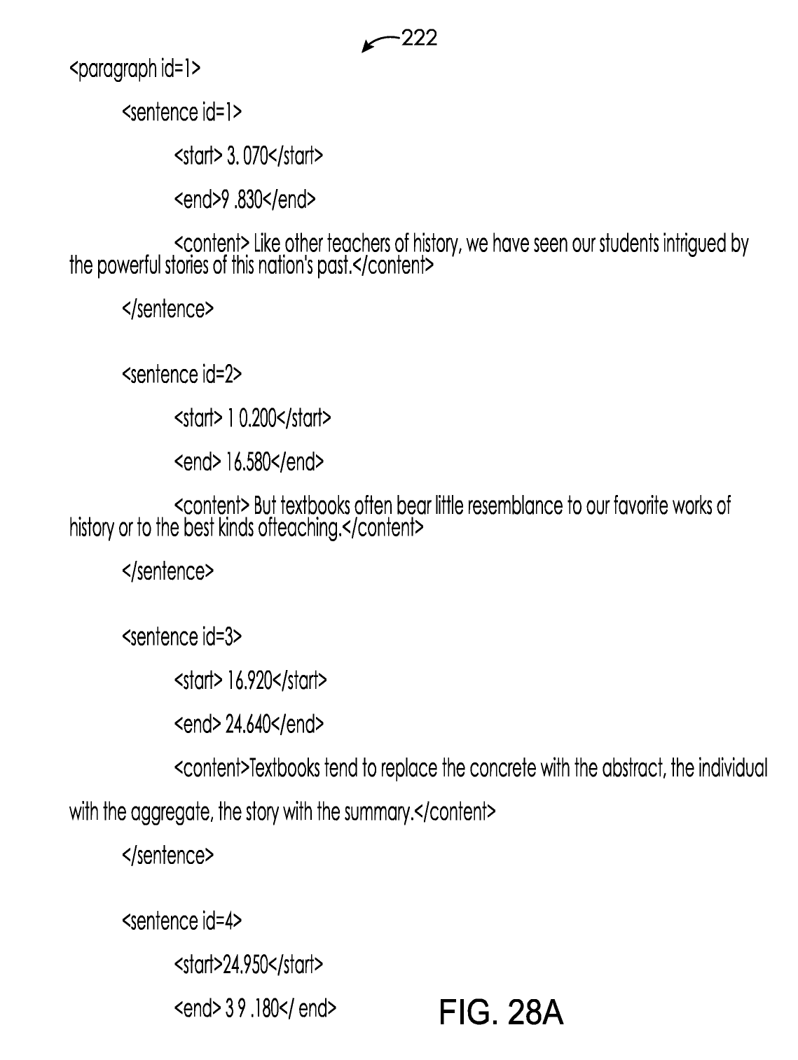

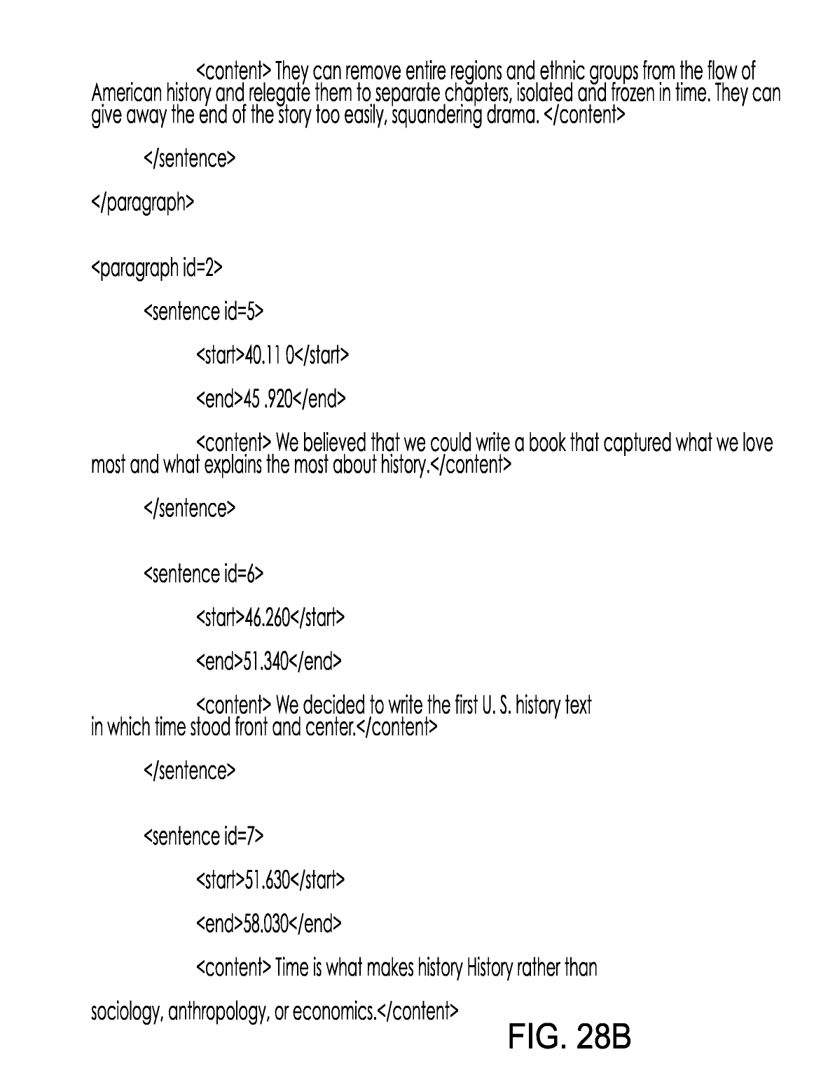

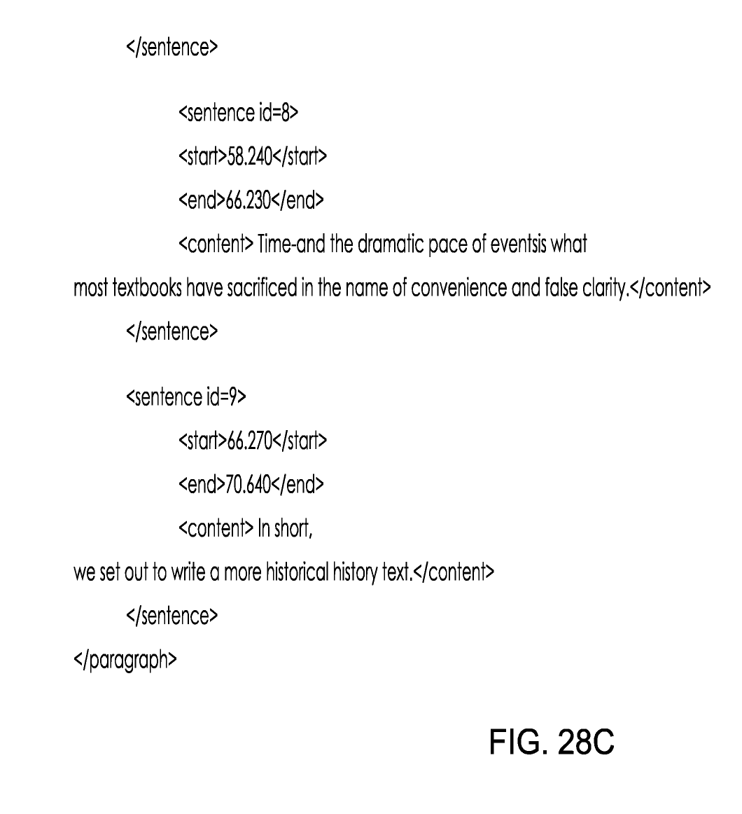

The method continues, as shown in FIG. 5, in block 510 where synchronized text/audio metadata is generated. Block 510 may be accomplished using text-to audio association logic 310, which associates the eBook text data 216 with the time-stamped text data 314. One of skill in the art will recognize that eBook text data 216 is a true and accurate representation of the final text associated with the time-synchronized talking eBook data 213, whereas the text 314 associated with the narration audio 212 may have errors due to demarcation speech-to-text converter logic 308 processing audio 212 or due to audio 212 itself (e.g., the narration may be incorrect). As such, the association logic 310 associates a time stamp from the time-stamped text data 314 with the accurate eBook text data 216 and generates synchronized text/audio metadata 222. Exemplary synchronized text-audio metadata 222 is illustrated in FIGS. 28A-C and includes metadata on paragraph number, sentence number, and start and end times for each sentence in audio 212 along with the text 216.

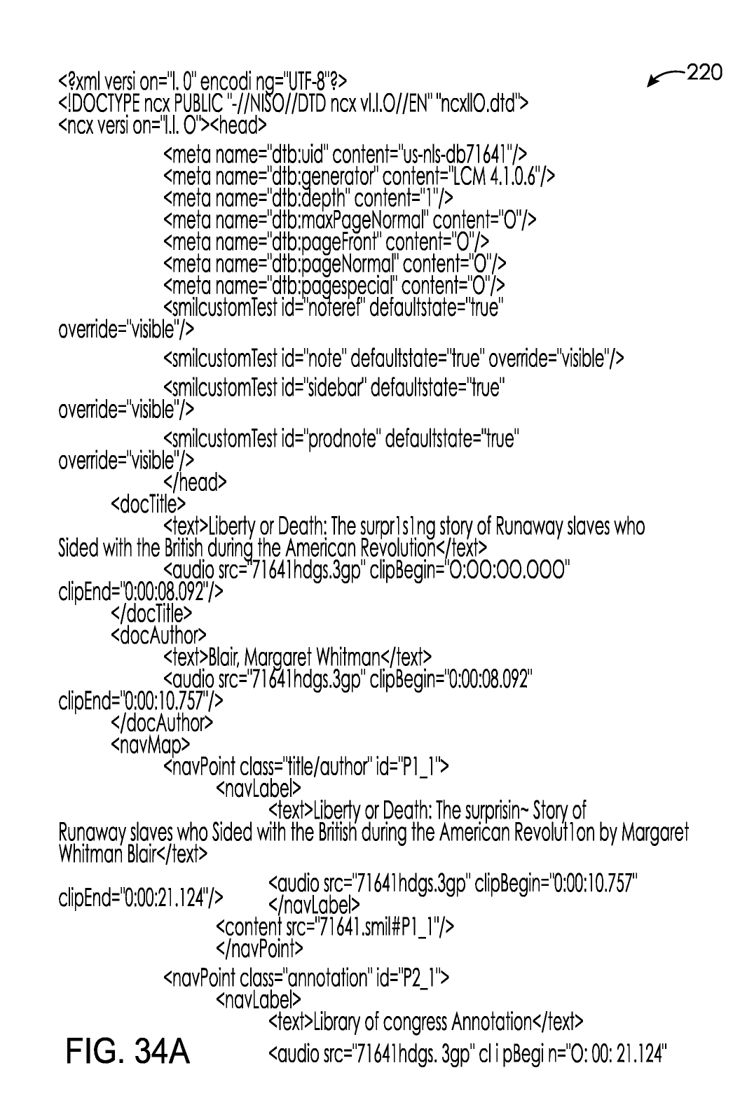

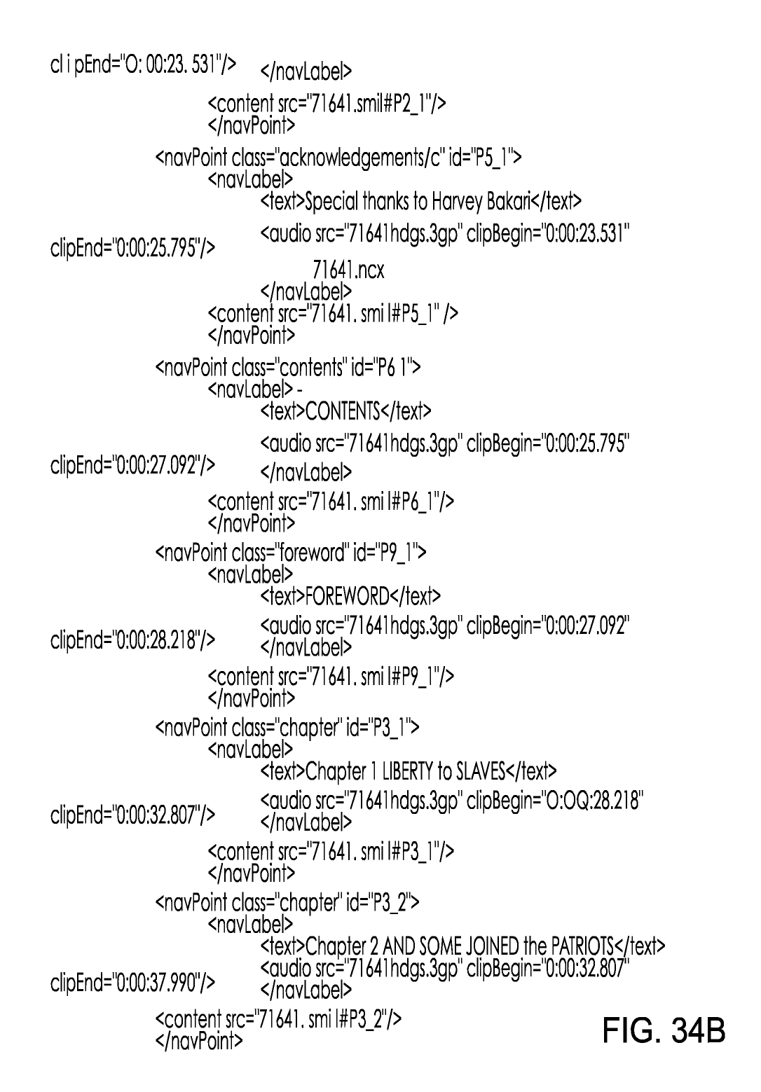

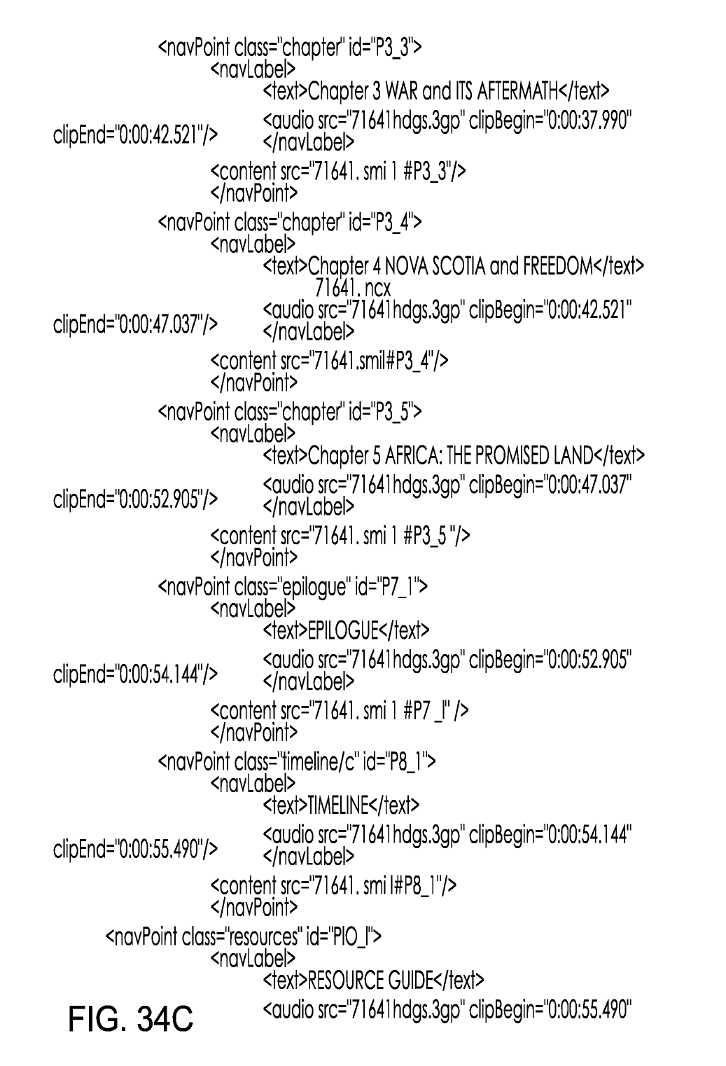

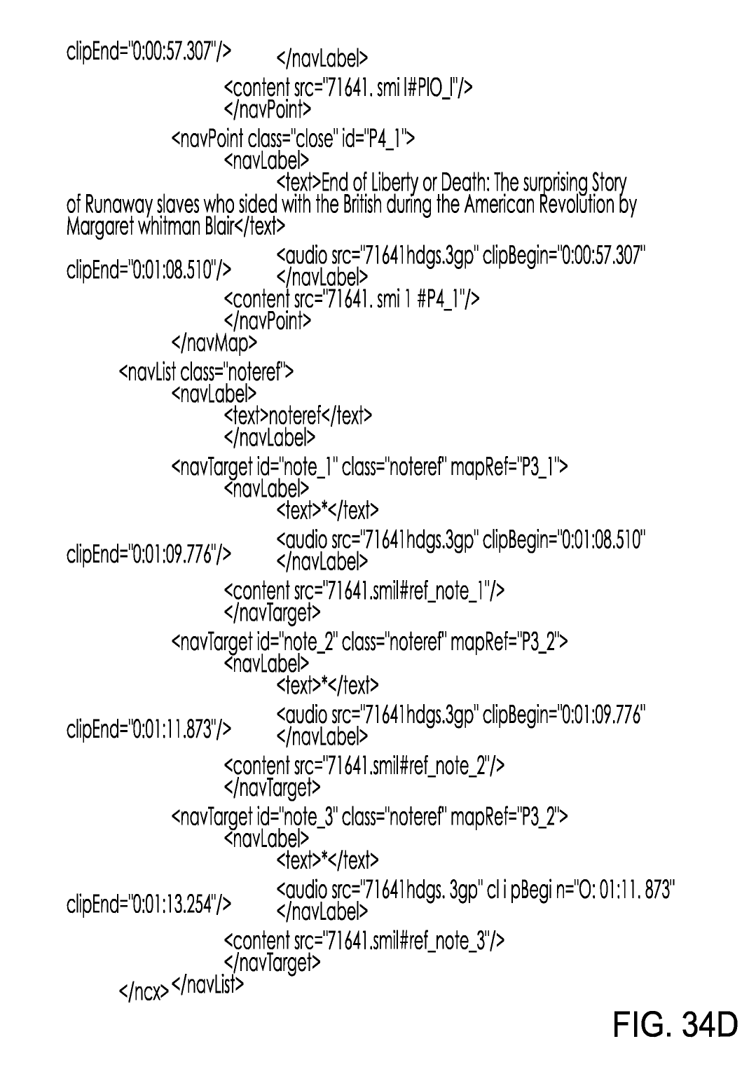

Finally, the method of FIG. 5 continues that block 512 where navigation control data is generated. Navigation control data 220 is data that allows an eBook reading device to associate text with audio on a sentence level and thereby allows a user to synchronize the display and playing of audio with text. In one embodiment, navigation control data 220 is generated by navigation control generation logic 312 based on synchronized audio metadata 222 and bibliographic metadata 218, in accordance with known methods. An example of navigation control data 222 is illustrated in FIGS. 34A-D. The method then concludes in block 514 where for example the bibliographic metadata 218, the eBook text data 216, the synchronized text/audio metadata 222, the navigational data 220, and the audio 212, collectively the time-synchronized talking eBook data 213 is stored in, for example, memory 108, for subsequence use or distribution as an eBook.

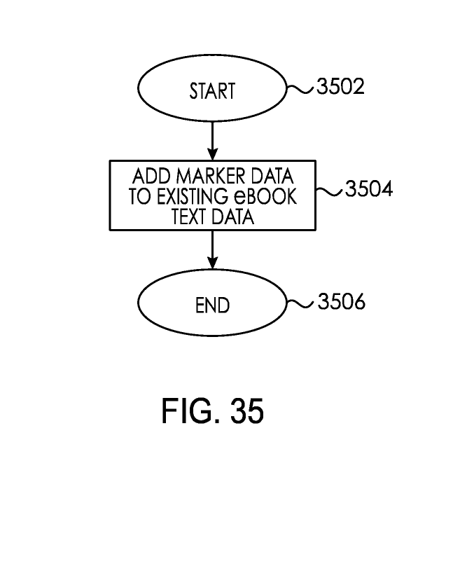

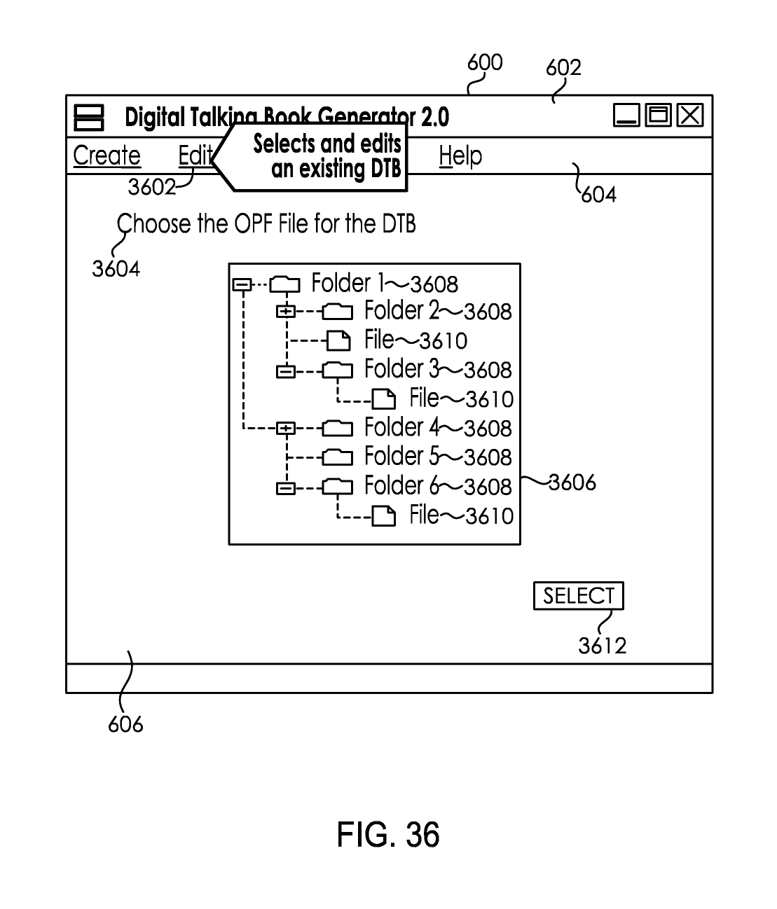

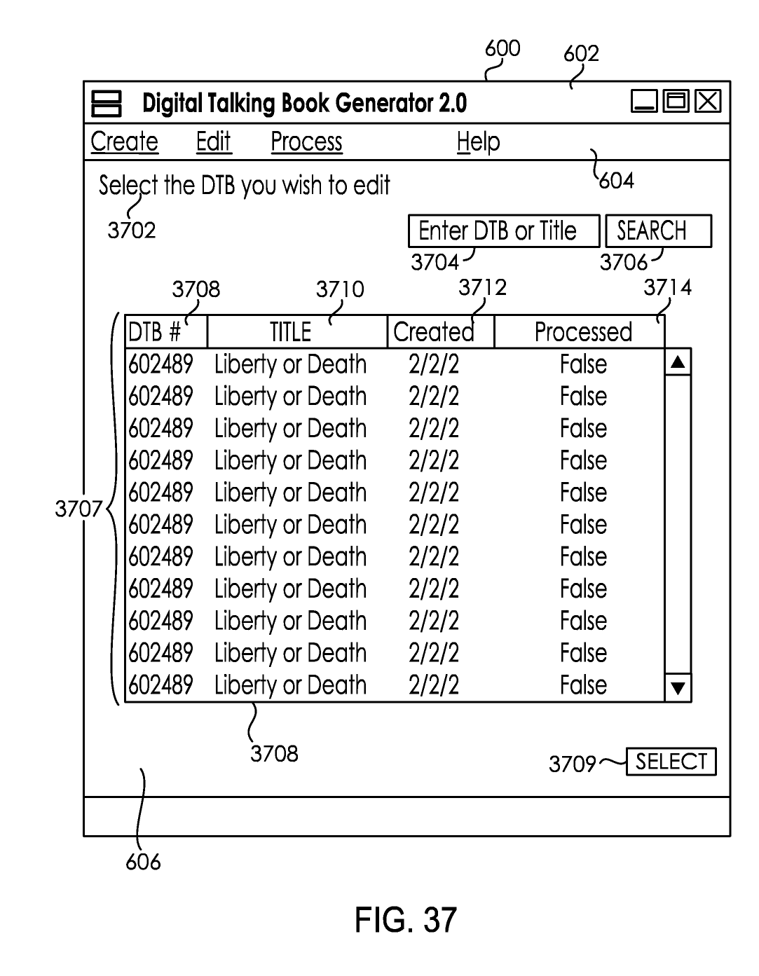

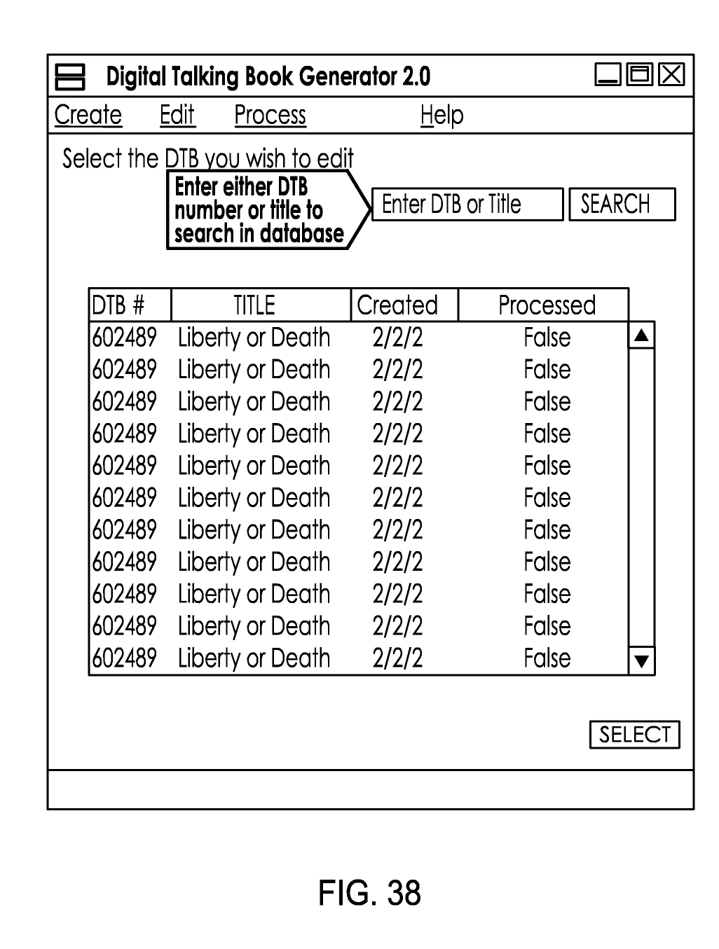

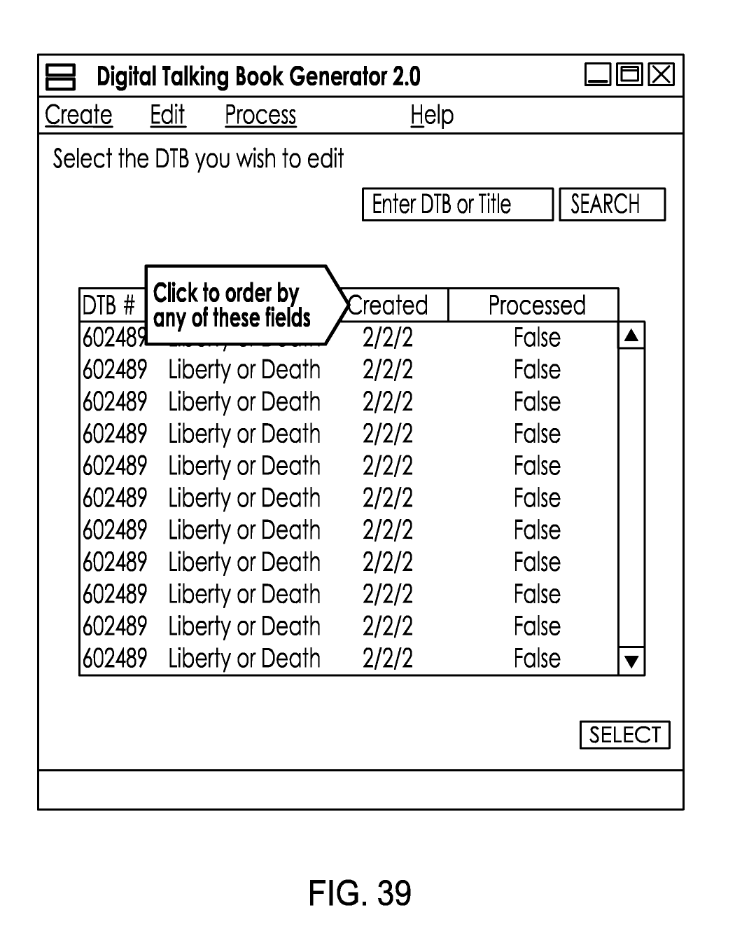

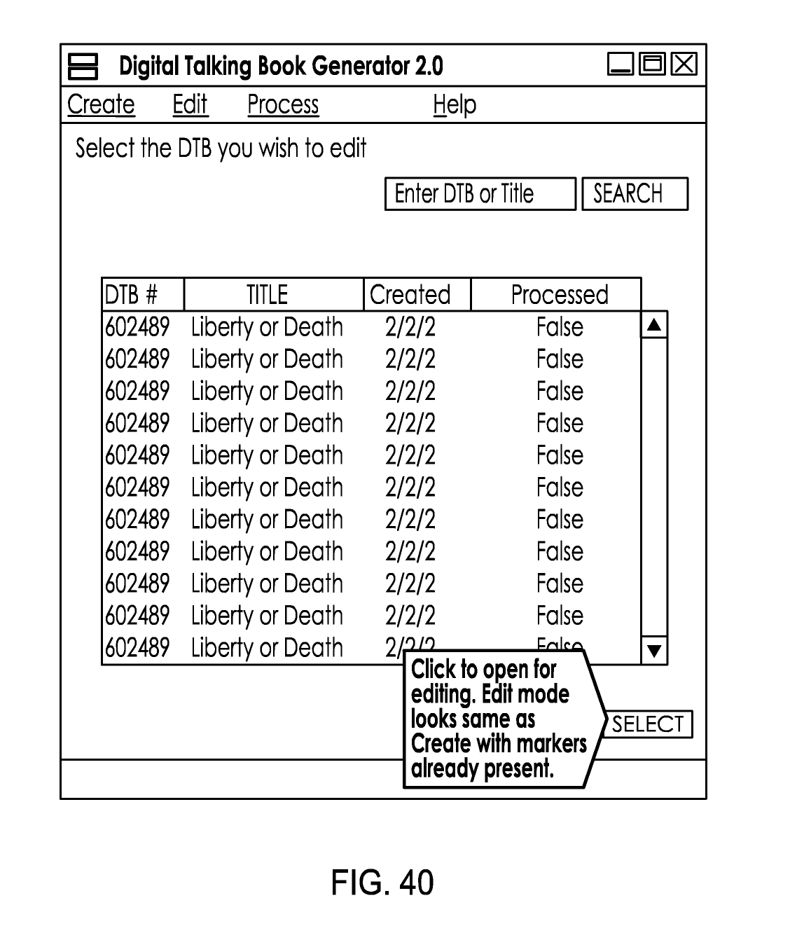

FIG. 35 shows a flow chart for editing existing eBook text data such as eBook text data 216 using time-synchronized talking eBook generation logic 100, and more particularly, the markation logic 306. The method begins in block 3502 where an existing digital talking book or eBook is identified using, for example, an OPF file such as OPF file 612 is associated with the previously existing digital talking book or eBook. With reference to FIGS. 36-40, identification of a particular existing eBook may be accomplished using GUI 600. In particular, a user may select an edit button 3602 as part of a title bar 604. In response, a prompt 3604 is displayed asking the user to choose a particular OPF file for editing. The user then is provided with a display window 3606 of folders 3608 and files 3610 associated with previously existing eBook and DTBs (“digital talking book.”) Alternatively, the method permits a user to select a visual talking book or eBook using a different methodology. In particular with reference to FIG. 37-40, GUI 600 may present the user with a window 600 containing a prompt 3702 asking the user to select a digital talking book the user wishes to edit. The user may select a book by entering a digital talking book or title in field 3704 and selecting the search button 3706. The results of the search 3707 are then populated within display window 3708 and may be organized by visual talking book number 3708, title 3710, creation date 3712, and process state 3714 (e.g., whether the text has been processed with the audio to generate an eBook). The user may then select individual results 3707 and select the select button 3709 to begin editing (e.g., adding, deleting or modifying) markers in block 3504 of FIG. 35 associated with the previous existing eBook text data 216 as previously described above with reference to FIGS. 13-22. Markers may be added or deleted in accordance as what has been described above. One of skill in art will appreciate that the process field 3714 and FIG. 37-40 is a field with a binary answer of true or false that indicates whether the digital talking book has been processed together with the audio to accomplish the end results of a complete digital talking book/eBook.

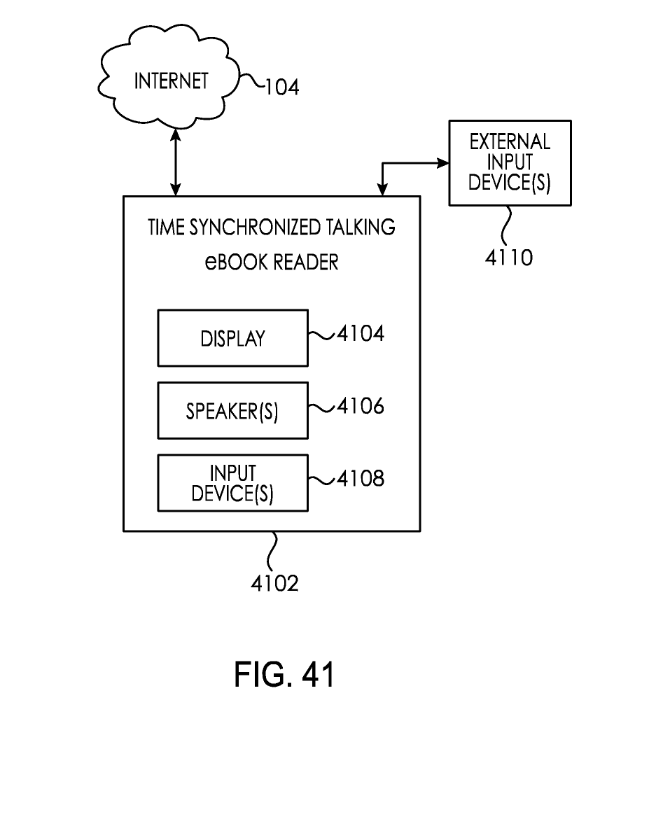

FIG. 41 is a block diagram of a time-synchronized, talking eBook reading device 4102 shown in an exemplary environment including in operable communication with Internet 104 and one or more external input devices 4110. Talking eBook reading device 4102 is preferably capable of displaying text and playing audio associated with an eBook title generated by time synchronized talking eBook generation logic 100. One of skill in the art will readily recognize the time-synchronized, talking eBook reading device 4102 may exist in an environment without communication with Internet 104 and external input devices 4110. As illustrated, time-synchronized, talking eBook reading device includes a display 4104, one or more speakers 4106, and optional one or more input devices 4108.

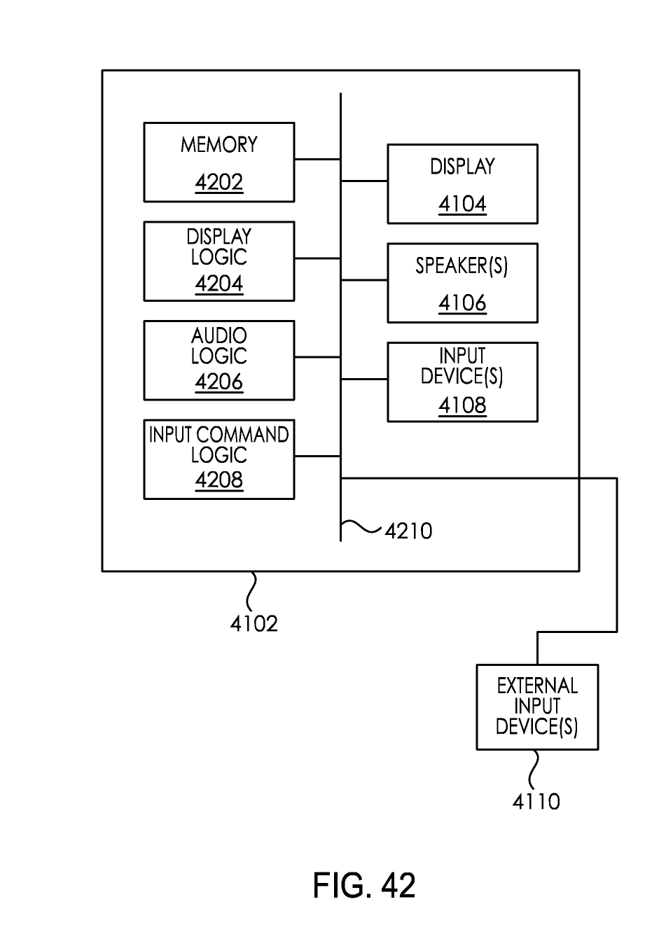

FIG. 42 illustrates an exemplary block diagram showing internal components of the time-synchronized, talking eBook reading device 4102 including display 4104, speakers 4106, input devices 4108, memory 4202, display logic 4204, audio logic 4206, and input command logic 4208. In the exemplary embodiment of FIG. 42 each the above described components are operably in communication with an internal bus 4210. One of skill in the art will recognize that the above described components may be in operable communication using other busses, communication links and internal infrastructures.

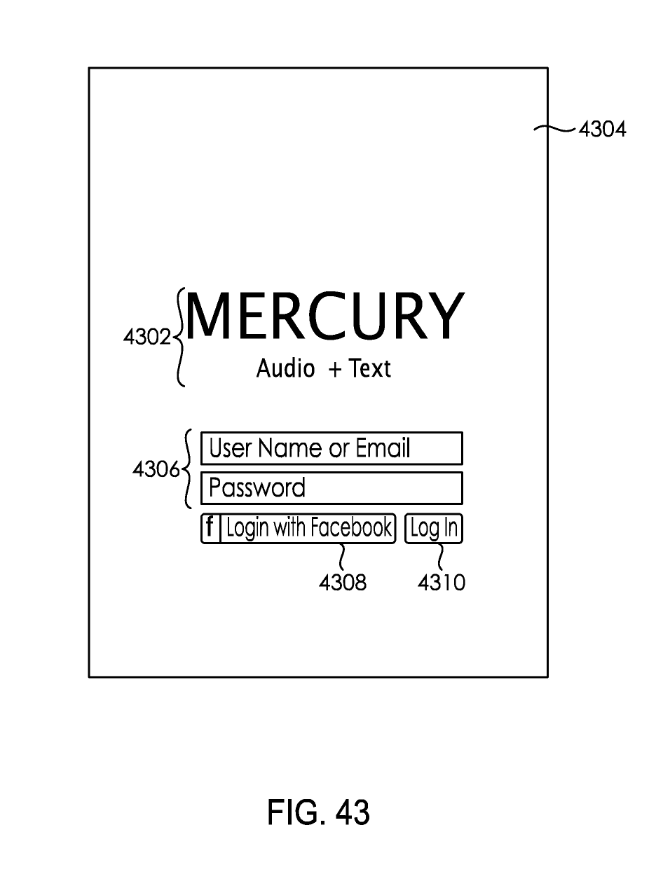

FIG. 43 illustrates a screen shot of a reader title page or window 4304 that may be displayed on the display 4104 of the time-synchronized, talking eBook reading device 4102. Upon power up, the window 4304 may include an introductory logo, tagline, or other welcome screen such as, for example, a splash screen 4302. The window 4304 may also include one or more fields 4306 whereby user credentials such as a username or email address and corresponding password may be input to log into the time-synchronized, talking eBook reading device 4102. Upon entry of such credentials in field 4306 a user may select the login button 4310 to effectuate login into the reader 4102. Alternatively, a user may log in by entering social media credentials and selecting the social media log in button 4308.

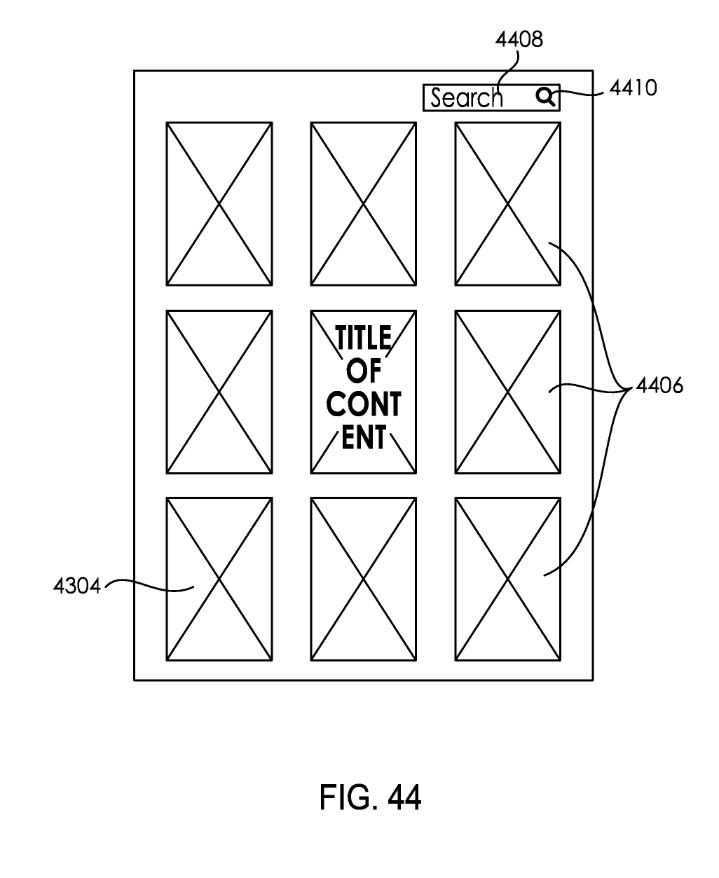

FIG. 44 shows a content menu pane for time-synchronized, talking eBook reading device 4102 that is displayed upon successful login into the reader. In particular, the window 4304 includes a plurality of content covers 4406 corresponding to the eBook titles that have been uploaded or saved to the reader 4102 that may be available to a user for reading or listening. If the eBook data 213 does not include display data for a cover, the title of the eBook is displayed instead of the content cover. One of skill in the art will recognize that the window 4304 may be scrollable to allow additional content covers 4406 or title information to be displayed. In addition, the window 4304 provides a search field 4408 and a search button 4410 that permits a user to enter text and search for a particular title of an eBook.

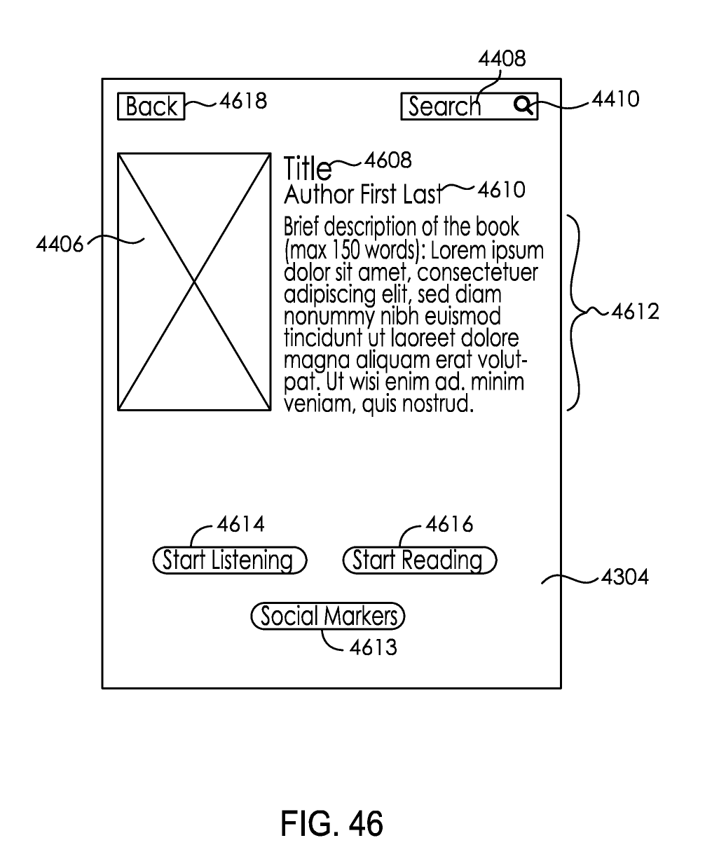

With reference to FIGS. 44 and 46, a user may select an eBook to read and/or listen to by selecting a content cover 4406 using an input device 4108, 4110. Upon selection of a particular eBook, the window 4304 of eBook reading device 4102 may display for the user a single content cover 4406 corresponding to the selected title, the title of the work 4608, the author information 4610, and a brief description 4612 of the selected content cover. One of skill in the art will recognize that the title 4608, author 4610, and description 4612 may be generated from bibliographic metadata 218 correspond to the selected content cover chosen by the user. The window 4304 may also include a start listening button 4614 and a start reading button 4616 that enables the user to either have the selected eBook played to the user using the audio data 224 or to enable the eBook reading device 4102 to display the text data 216 for the selected eBook, respectively. Also the window 4304 may include a social marker button 4613 that, when selected by a user permits the user of the eBook 4102 to view a variety of social comments and markers made by other users and/or friends linked to the user through one or more social networks. This occurs by the eBook connecting to a server (e.g., over the Internet) and retrieving the markers created by social connections of the user. The server maintains a cross-reference database of a user's social friends. The server will deliver any social markers between friends when requested from the book. The window 4304 also includes a back button 4618 allowing a user to return to the window 4304 illustrated in FIG. 44, and to allow the user to make a new selection of a eBook for viewing and/or listening.

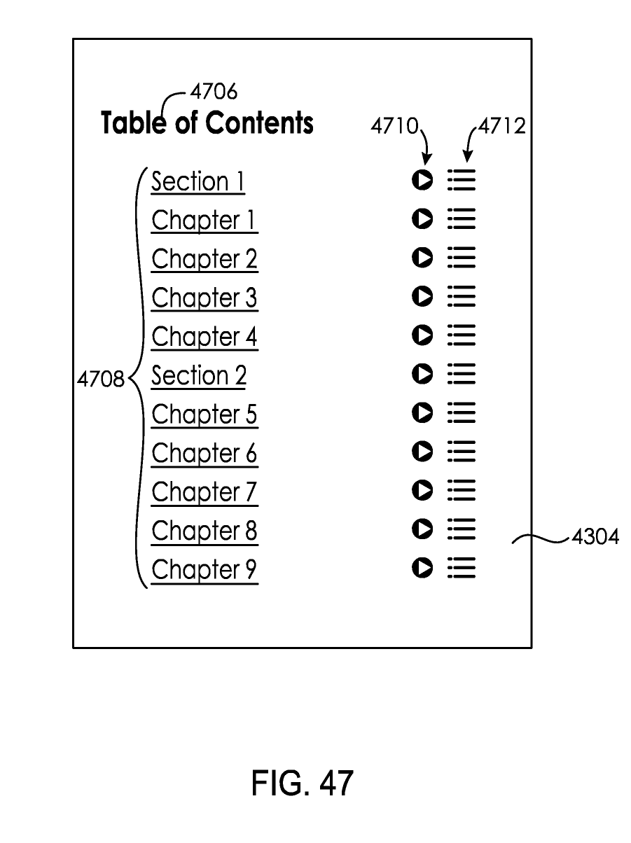

FIG. 47 is a block diagram of reader 4102 illustrating an exemplary window 4304 that may appear upon user selection of the start reading button 4616 of FIG. 46. Upon selection of the start reading button 4616, a table of contents screen 4706 is displayed within the window 4304 showing the various sections and chapters 4708 associated with the selected title of the selected eBook. Each of the sections and/or chapters listed 4708 is a hyperlink that permits the user to select the chapter or section number and go to that point in the text. The hyperlink uses the navigation control data 220 to make such a link or a “jump.” Alternatively, a user may select the play icon 4710 corresponding to the section or chapter corresponding to the particular section or chapter 4708. Selection of the play icon 4710 allows the user to listen to audio 212 from that point in the eBook. A user may also select a sub-section index icon 4712 associated with the section or chapter 4708 that allows the user to see further features such as linked video, illustrations or other features and data associated with the section and/or chapter.

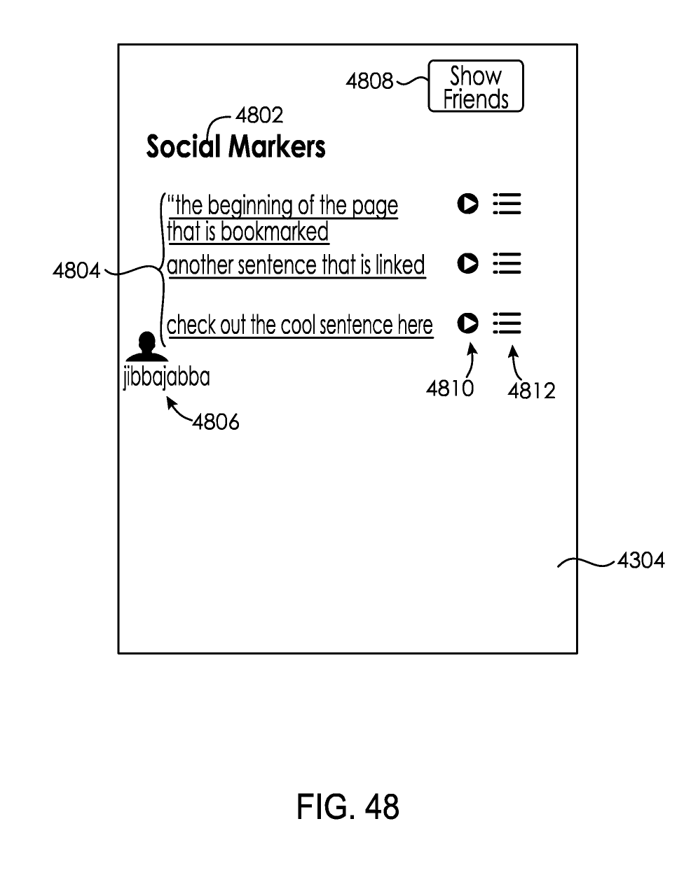

FIG. 48 is a block diagram of eBook reading device 4102 with an exemplary window 4304 following selection of the social markers button 4613 from FIG. 46. The window 4304 of FIG. 48 includes a social markers screen title 4802 indicating that the display is associated with and showing available social markers 4804 corresponding to the text. Social markers 4804 may include comments, video, audio, highlighting and other information/data created by the friend that preferably relate to the eBook. Social markers 4804 may be organized, for example, by order of appearance in the content of the eBook 4804. Adjacent to the listing of markers 4804 is a play icon 4810 allowing users to play the text associated with the markers 4804 as marked by social media friends. Adjacent to the play icon are sub-section indices 4812 which, if selected by a user, present the user with a new window 4304 with additional, more detailed markers info/data with the markers 4804. To the extent the marker is by a “friend” in a social media network, the friend's profile image 4806 and name is displayed next to the social marker 4804 associated with that friend. Finally display 4304 includes a show friends button 4808 which, when toggled by a user, display or hides the friend markers 4806 associated with friends of the use.

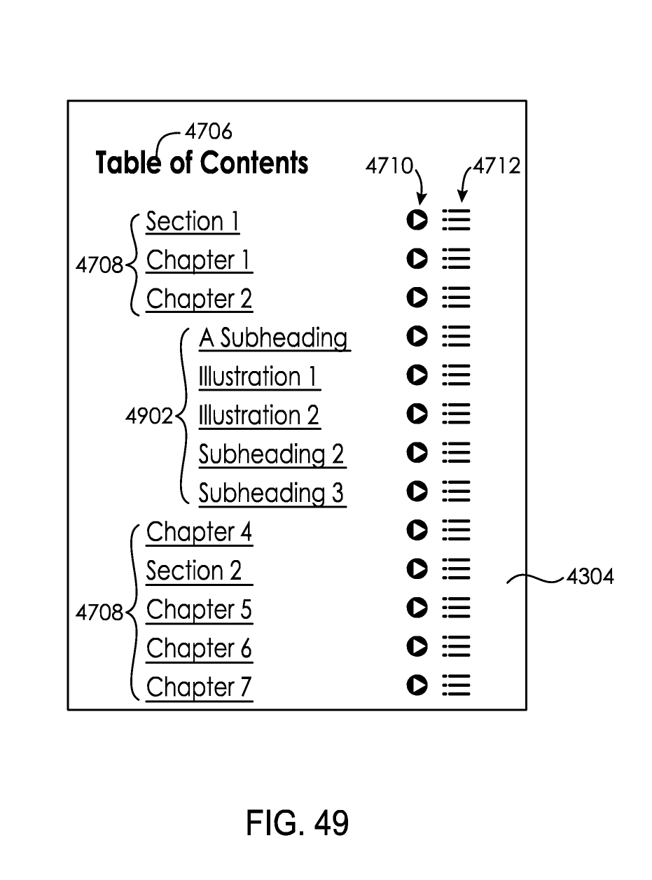

FIG. 49 illustrates a block diagram of reader 4102 with an exemplary window 4304 following selection of the sub-section index 4712 from FIG. 47. For example, when the user selects the sub-section index associated with chapter 2 from FIG. 47, the display in FIG. 49 is illustrated which shows further table of contents detail 4902 associated with chapter 2. In particular, the display 4304 illustrates additional table of contents hyperlinks 4902 associated with chapter 2 such as sub-heading 1, illustration 1, illustration 2, sub-heading 2, and sub-heading 3.

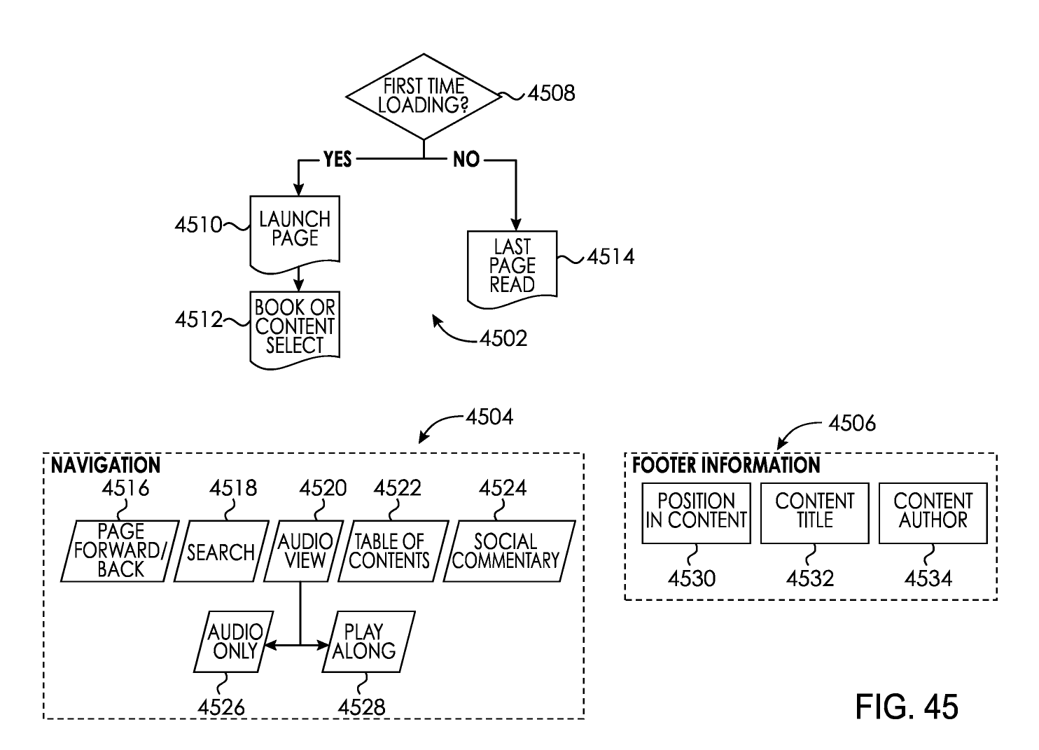

A user's reading experience is described as reference to FIGS. 45, and 50-64. eBook reading device 4102 allows a reader to select the point in the eBook where display of text should begin. For example, a user may select to begin an eBook at the very beginning (e.g., with the introductory pages, prologue, or other note(s) from the author or publisher and/or at chapter 1.) Alternatively, a user may browse to one or more other areas within the book using, for example the table of contents previously described above to reference to FIG. 47 and/or one or more sub-section index icons 4712 as generally described with reference to, for example, FIGS. 48 and 49.

FIG. 45 describes one flow 4502 of this process. The flow begins at block 4508 where after an eBook has been selected (e.g., through selection of buttons 4614 and 4616), it is determined whether the selected eBook has been loaded before. If the eBook is being loaded for the first time on the reader, the method may continue, in one embodiment, at block 4510 where the table of contents page 4706 is displayed and the user can select where to begin reading or listening at block 4512. If the eBook has been loaded before, the method continues in block 4514 where the user previously stopped reading and/or listening to the eBook. The persistent state is saved in local storage of the device 4102 (e.g., memory 4202).

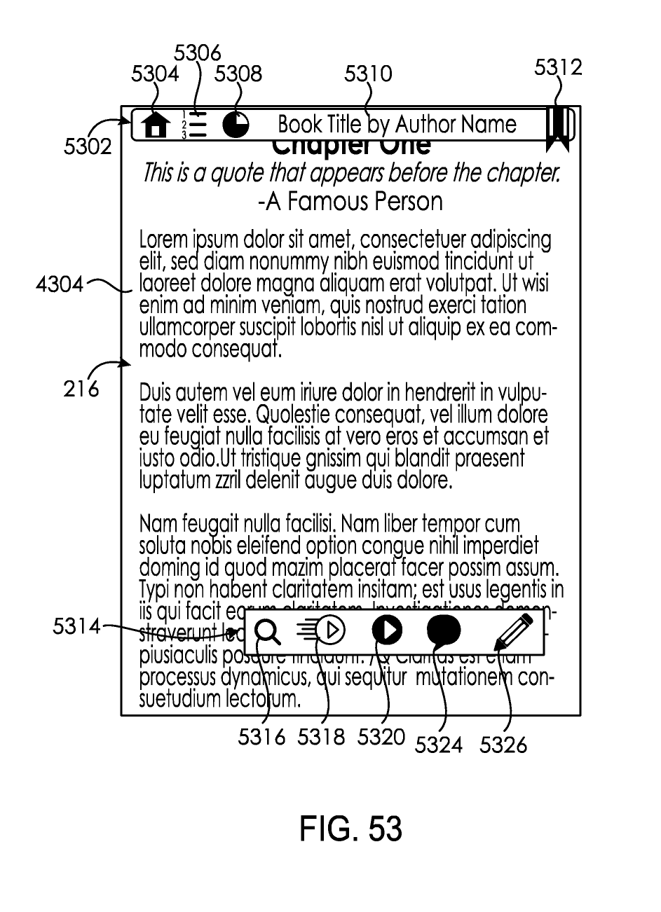

FIG. 45 additionally illustrates a navigation layout 4504 as presented on a navigation bar 5314 and an information layout 4506 as presented on an information bar 5302, such as shown for example in FIG. 53. In reference to FIG. 45, the navigation layout 4504 includes a page forward or backward module 4516, a search module 4518, an audio view module 4520, a table of contents module 4522, and a social commentary module 4524. Moreover, the navigation layout 4504 may include an audio only module 4526 and a play along module 4528 that may be invoked in response to the audio view module 4520 being selected. Similarly, the information layout 4506 may include a position in content module 4530, a content title module 4532, and a content author module 4534.

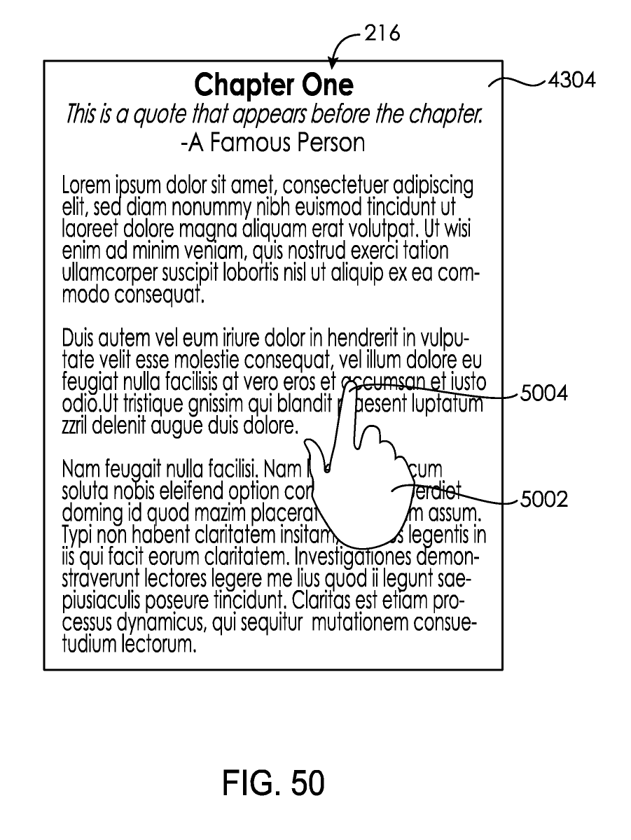

Once the eBook text 216 is displayed on the window 4304, the reading experience is without any overlay button that would obstruct everything by the user. The layout of the eBook matches the physical book as best as possible given certain limitations of the code and the display. When a user 5002 taps 5004 on the screen, as shown in FIG. 50, this toggles navigational buttons on and off. Continuously depressing the screen 5004, for example using an index finger of hand 5002, holds open the navigational buttons. Navigational buttons are discussed with reference to FIG. 53 below.

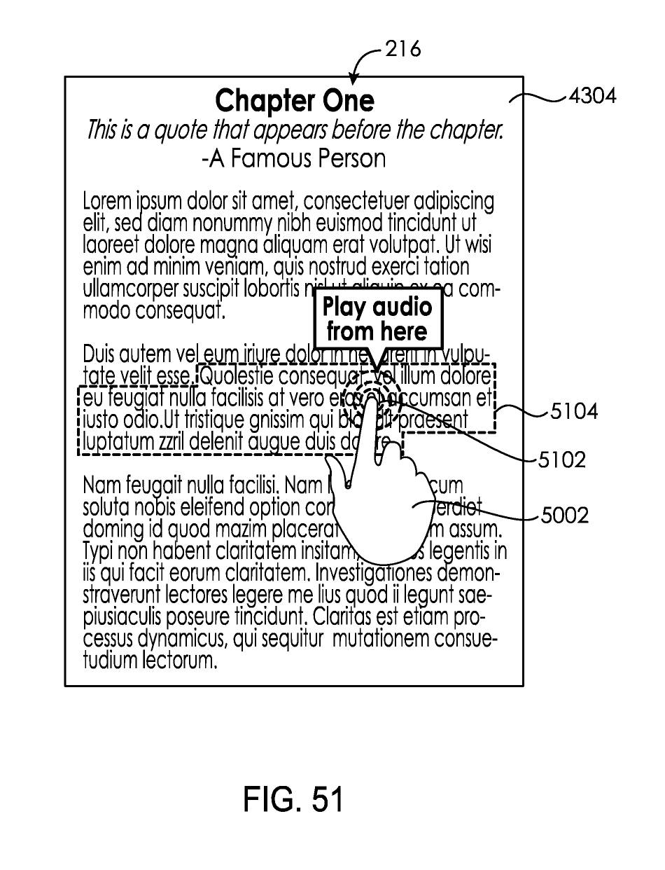

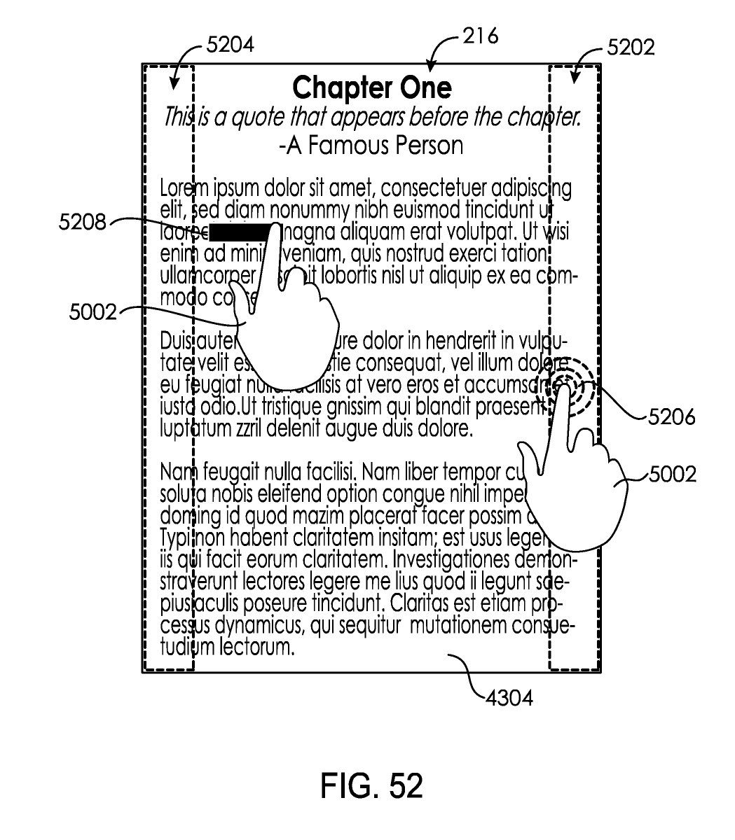

Reference to FIG. 51, holding down on specific text 5102 using hand 5002 activates the ability of the user to play audio associated with that text 5102. The audio portion that will be played becomes highlighted 5104. With reference FIG. 52, the user can change pages within the book using two methods. The first method is to tap 5206 on the corner columns 5202 and 5204 to change the page forward or backward, respectively. For example, tapping column 5202 will pull the page forward whereas tapping the column 5204 will pull the page backward. Alternatively, a user may swipe on the page 5208 to change the page backwards or forwards. Swiping forward (towards the right) may, for example, shift the page forward whereas swiping backwards (towards the left) may, for example, change the page backwards.

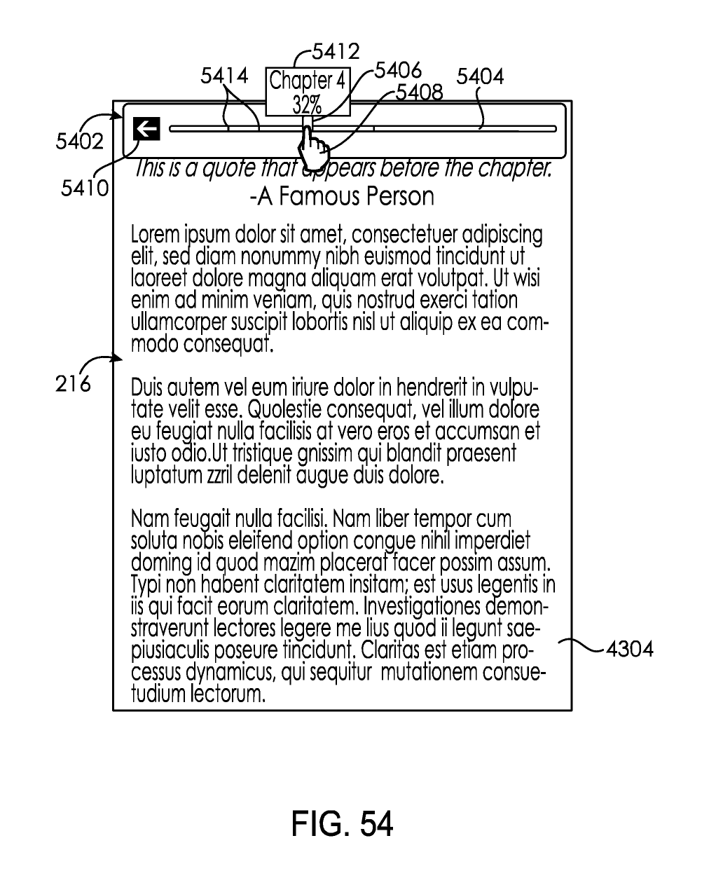

With reference to FIG. 53, Navigation buttons are presented on navigation header bar 5302 and navigation footer bar 5314. Navigation header bar 5302 includes home icon 5304, a table of contents icon 5306, a relative position icon 5308, title and author information 5310, and a bookmark icon 5312. Tapping the home icon 5304 will redirect the user to the home or content selection menu or page of FIG. 44. Tapping the table of contents icon 5306 will redirect the user to the table of contents screen as illustrated above with reference to FIG. 47. The relative position icon 5308 displays the position of the current page relative to the total number of pages in the eBook. The relative position may take the form of a pie chart where the white portion represents that portion which has been read and based on the assumption that all previous pages have already been read. Clicking the relative position icon 5308 redirects the user to a changed position menu discussed and referenced with FIG. 54. The bookmark icon 5312 enables the user to select and bookmark the particular page currently displayed on the eBook reading device 4102. Once selected, the bookmark will appear in a table of contents screen to notify the user of one or more bookmarks associated with the eBook text 216.

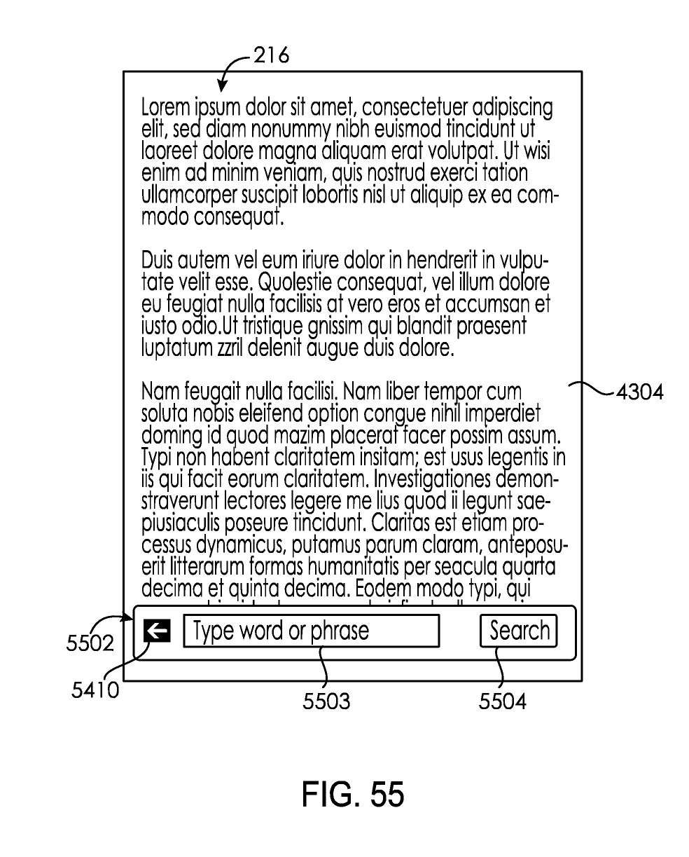

Footer navigation menu 5314 includes a search menu icon 5316, a play audio with text icon 5318, a switch to audio play mode 5320, a social commentary icon 5324, and a marker button 5326. Selection of the search icon 5316 will pull up a search bar as described in FIG. 55. Selection of the play audio with text icon 5318 will result in the eBook reading device 4102 playing the audio associated with the text 216 displayed at the top of the window 4304.

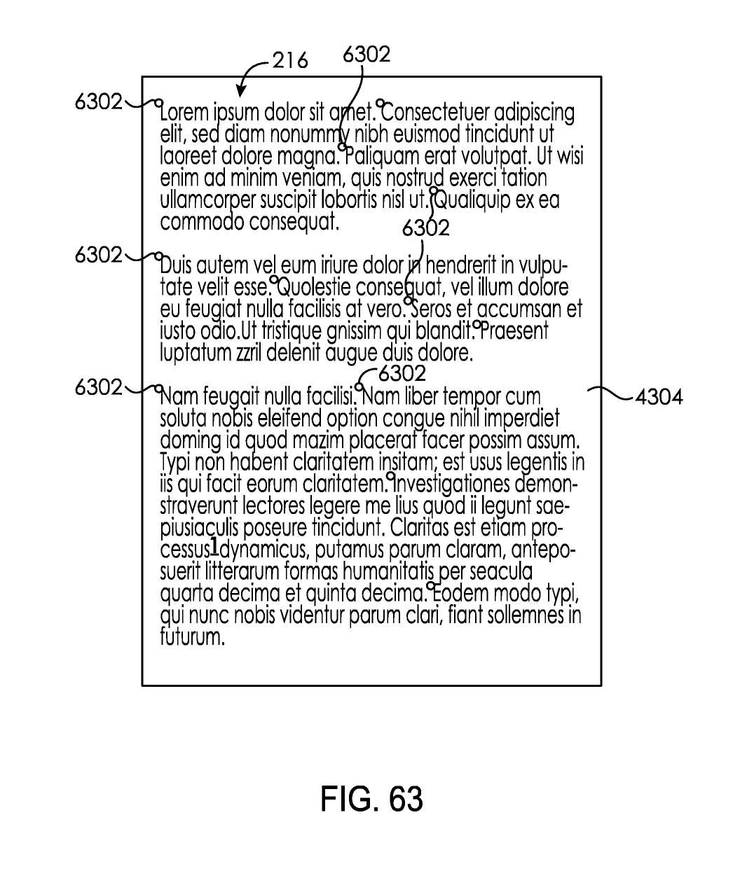

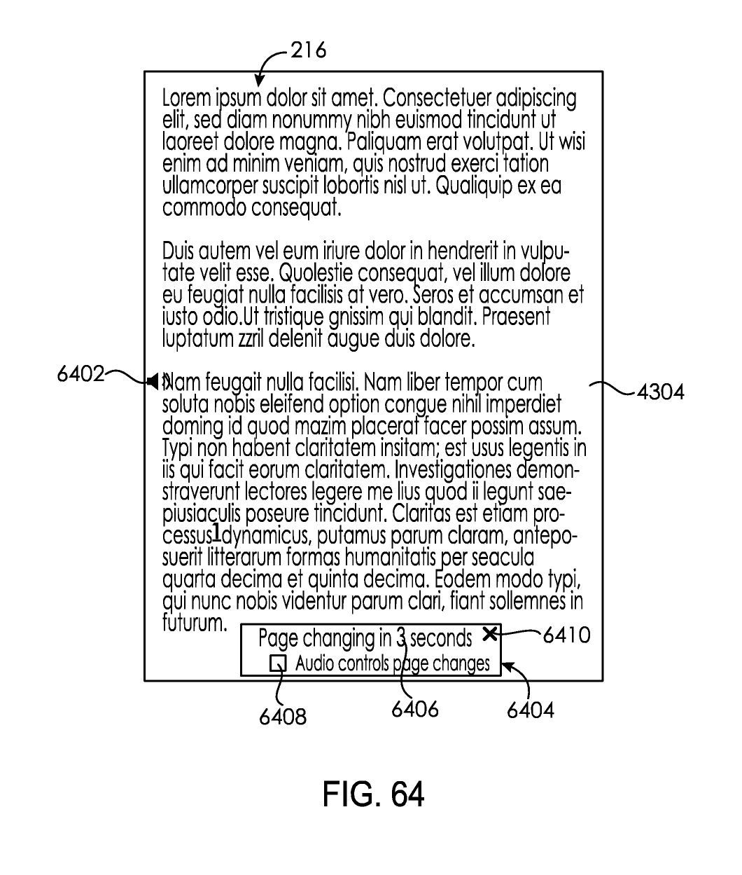

Upon selection of the play audio with text icon 5318, a plurality of play icons 6302, as shown in FIG. 63, may be displayed within the window 4304 of the eBook reading device 4102. Upon selection of a play icon 6302, playback of audio will start at the point in the text where the play icon 6302 was displayed. Once the audio begins playing on the one or more speakers 4106, a speaker icon 6402 is preferably displayed adjacent to that portion of the text that is being played. While the text is displayed and read, an audio status window 6404, as shown in FIG. 64, is displayed preferably on the bottom portion of the window 4304. This audio status window 6404 indicates when the page will change 6406 (e.g., in seconds). Window 6404 includes a close button 6410 that allows a user to close the audio status window 6404, thereby freeing up more real estate on the display. Window 6404 also includes a radio button 6408 that allows the user to select or deselect the option of allowing the audio to control when the pages changed 6408. If selected the audio will control when the pages change (e.g., when the audio played reaches the bottom of the page being displayed). If unselected, the page does not change unless manually done so by the user as described above.

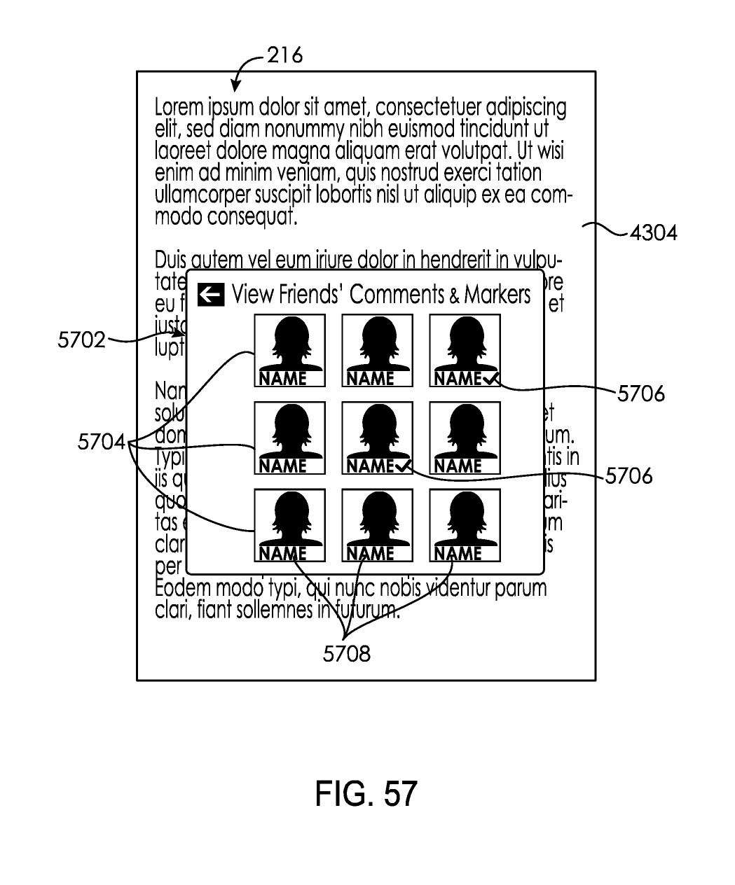

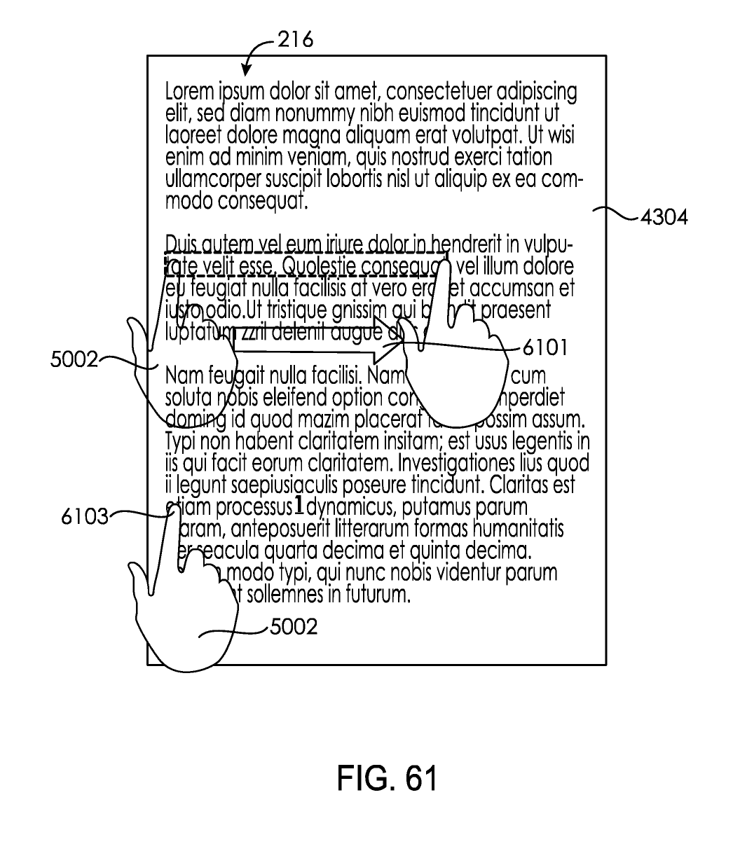

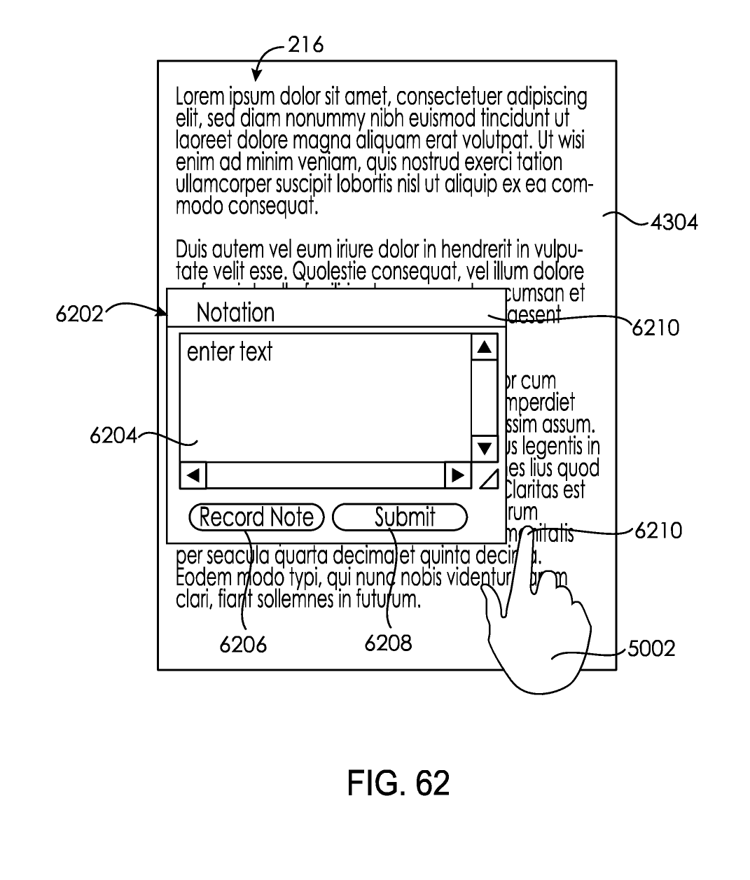

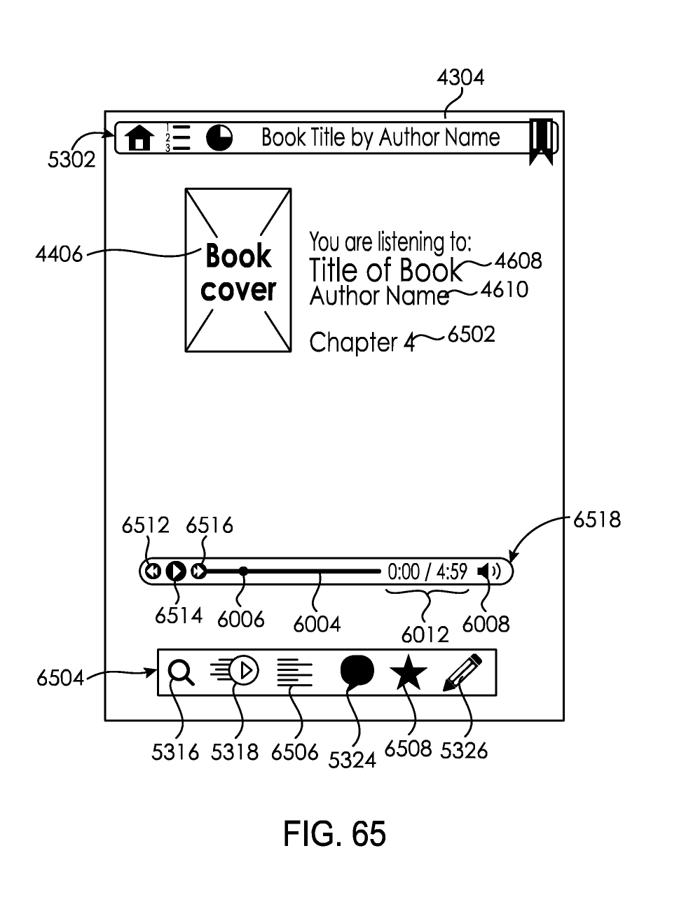

Upon selection of the switch to audio play mode 5320 icon, a plurality of play markers 6302 may be displayed on the display 4304 of eBook reading device 4102. Play markers 6302 enables the user to jump to a particular segment of audio associated with the text 216. Upon of selection of such a marker, the eBook reading device 4102 plays the audio at that point. Selection of the switch to audio icon 5320 switches the eBook reading device 4102 to audio mode as described below with reference to FIG. 65-68. Selection of the social commentary icon 5324 is described below with reference to FIGS. 57-60, and selection of the marker icon 5326 is describe reference to FIGS. 61-62.

With reference to FIG. 54, a change position window 5402 appears upon selection of the relative position icon 5308 as shown in FIG. 53. The change position window 5402 includes a bar 5404 with a slider 5406 representing the current location of the page relative to the entire eBook. A user may select 5408 the slider 5406 and move it forward or backward through the eBook to permit the display of a new portion of the eBook text 216. When the user selects the slider 5408 a navigation window 5412 appears showing the current chapter and the percent of the text that has already been read/displayed associated with the eBook based on the assumption that all previous content was read/displayed. A plurality of lines 5414 may also be used and displayed illustrating the relative position within the text 216 of markers made by the user and/or others (i.e. friends associated with the user on a social media network). The change position window 5402 also includes a back button 5410 that will redirect the user to the previous sentence(s).

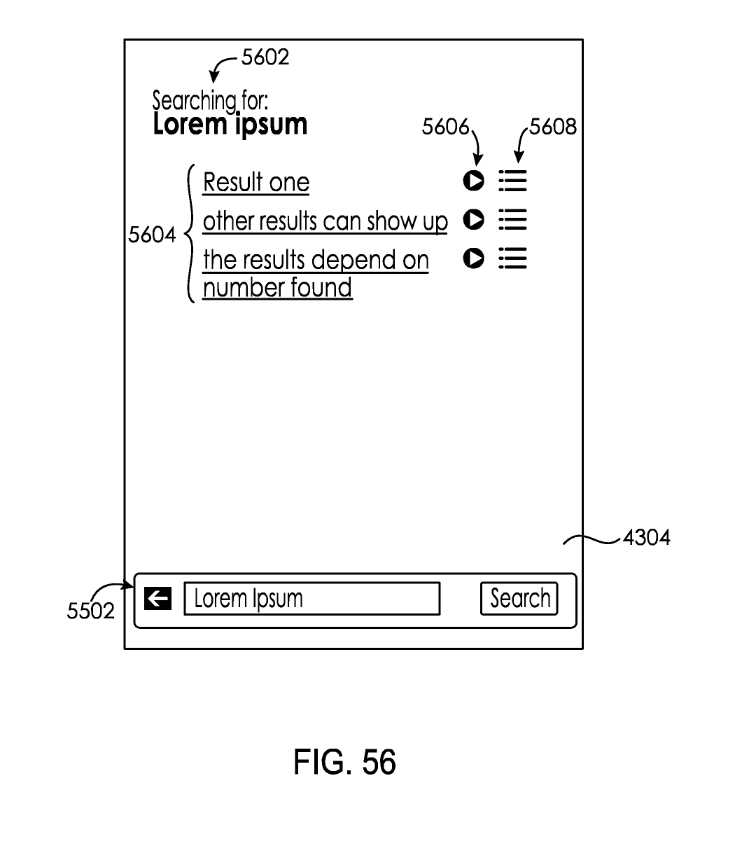

FIG. 55 illustrates an exemplary search window 5502 displayed upon user selection of the search icon 5316, as shown in FIG. 53. Search window 5502 includes text box 5503 in which a user may type words or phrases that the user wishes to find within the eBook text 216, and a search button 5504 that instructs the eBook reading device 4102 to find those word(s) or phrase(s) within the eBook text 216. Search window 5502 also includes a close button 5410 that removes the search bar from the screen. Upon selecting the search button 5504 of FIG. 55, display results 5604, as illustrated in FIG. 56, are shown for the search term 5602. The results 5604 are linked to that portion of the eBook text 216 where the term is located so that the user may select a result and jump to that portion of the eBook text 216. Adjacent to the search results 5604 are audio button 5606 and sub-section icons 5608. Selection of the audio button 5606 results in playback of the audio corresponding to the text 216 at the point where the search results are found in the text. The subsection icons 5608 permit the chapter bookmarks to include any bookmarks, subheadings, and other navigational markation within the chapter as specified by either the content publisher or the user.

Referring back to FIG. 53, in response the selection of social commentary button 5324, a social commentary window 5702, as shown in FIG. 57, is displayed within the window 4304. Preferably the window is slightly opaque and is placed over a portion of the eBook text 216. Window 5702 illustrates those friends that have made comments and/or markers to the eBook text 216 currently being viewed by the user. In one embodiment profile pictures and names are displayed within the window 5702. In other embodiments simply the names of friends that have commented or marked the text are displayed in 5702. Window 5702 allows a user to check or select the comments of friends that it would like to view or listen to by selecting radio buttons 5706 associated with the friends. The selection of radio buttons 5706 will show comments and markers from the selected friends, non-selected profiles from 5708 result in the user not seeing comments and markers from the non-selected users 5706.

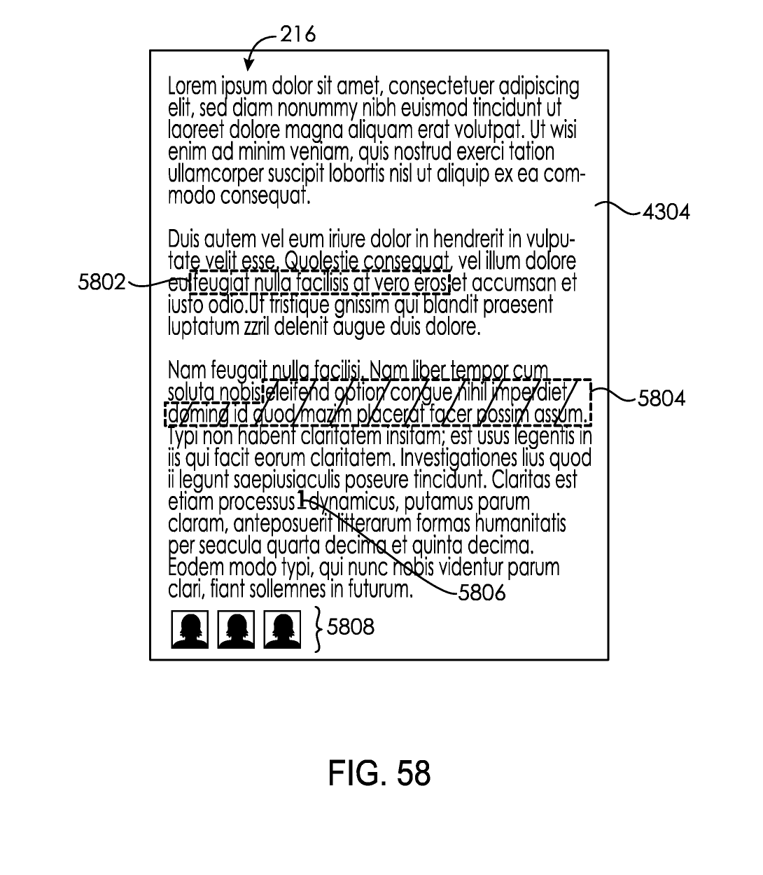

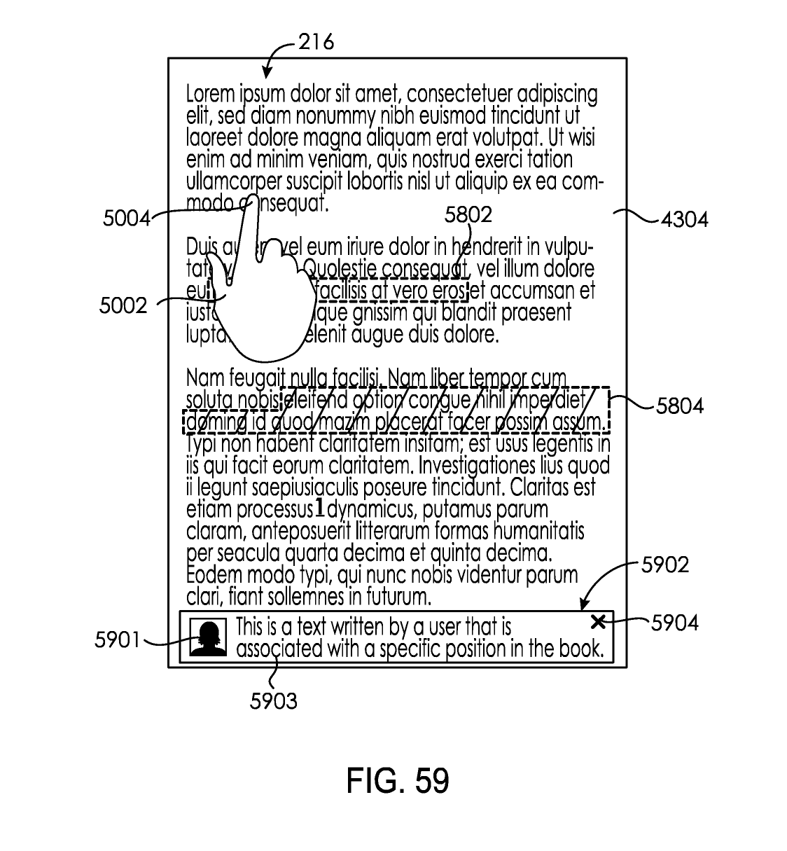

Reading social comments from friends is much the same as reading eBook text 216 as described above. Once friends are selected, their comments and markers are displayed on the window 4304 as illustrated in FIG. 58. Each friend may be automatically assigned a display color. If any friend has left a comment on the page that is currently being displayed, an indicator 5808 may appear at the bottom of the page. In one embodiment, the indicator 5808 is the user's profile picture. Comments and the text 5802, 5804 corresponding to comments are illustrated as footnotes 5806 each linking to a display of the comment. When a user selects indicator 5808 or footnotes 5806, a comment window 5902, as illustrated in FIG. 59, is displayed showing the friend's profile 5901 and the comment 5903. Close icon 5904 and tapping the display 4104 returns the user to the reading screen and closes the comment window 5902.

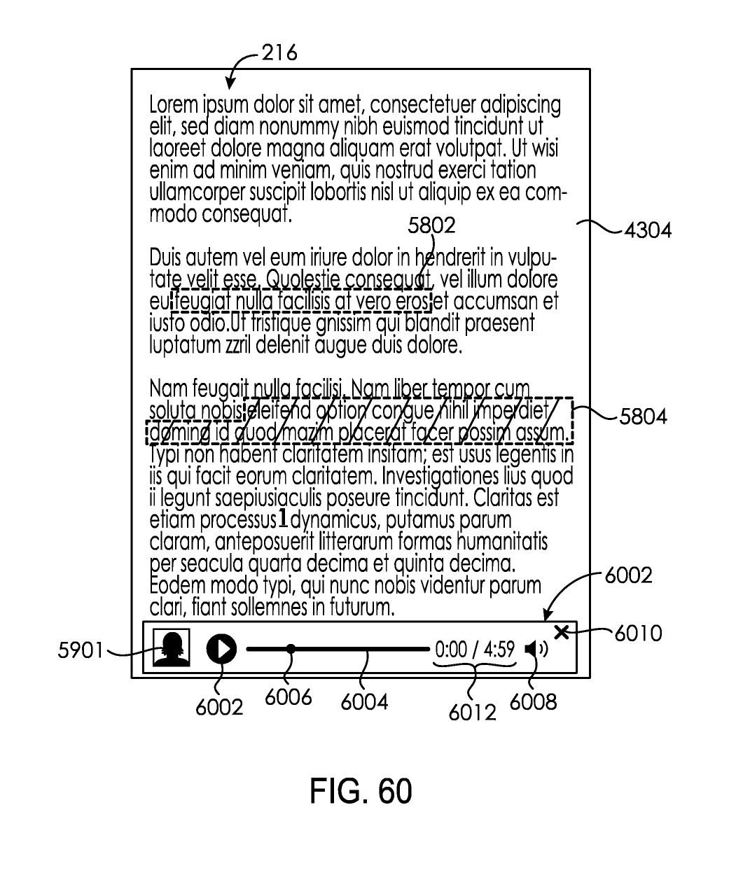

Friends may also leave audio footnotes for other users to enjoy and listen. For example, footnote 5806 may correspond to an audio footnote left by a friend. If selected by the user of the eBook 4102, audio footnote 5806 causes audio window 6002, as shown in FIG. 60, to appear which is similar to the text window 5902 described above. Audio window 6002 includes a profile picture 5901 of the user who left the audio footnote, a play button 6002, a bar 6004 and slider 6006, as well as time information 6012 illustrating the relative position of the playback relative to the total length of the audio footnote, a close button 6010 that closes window 6002 and a volume button 6008 that controls the volume of the playback of the audio footnote.

A user is also able to mark eBook text 216 by highlighting the text. Referring to FIG. 61, a user may highlight a relevant portion of the text by swiping 6101 the relevant passage. Double tapping 6103 the display 4104 using hand 5002 opens up a notation window 6202, as shown in FIG. 62, that allows the user to leave a notation at that content point which is being tapped. For example, notation window 6202 allows the user to enter text 6204 associated with the eBook text 216 at the tapping point 6103 of FIG. 61. Alternatively, a user may record an audio note that will be displayed as a footnote by selecting the 6206 record note button. The user then selects the submit button 6208 to submit the notation or note for display with the eBook text 216. The comment may be then be associated with other friends of the user through social media networks.

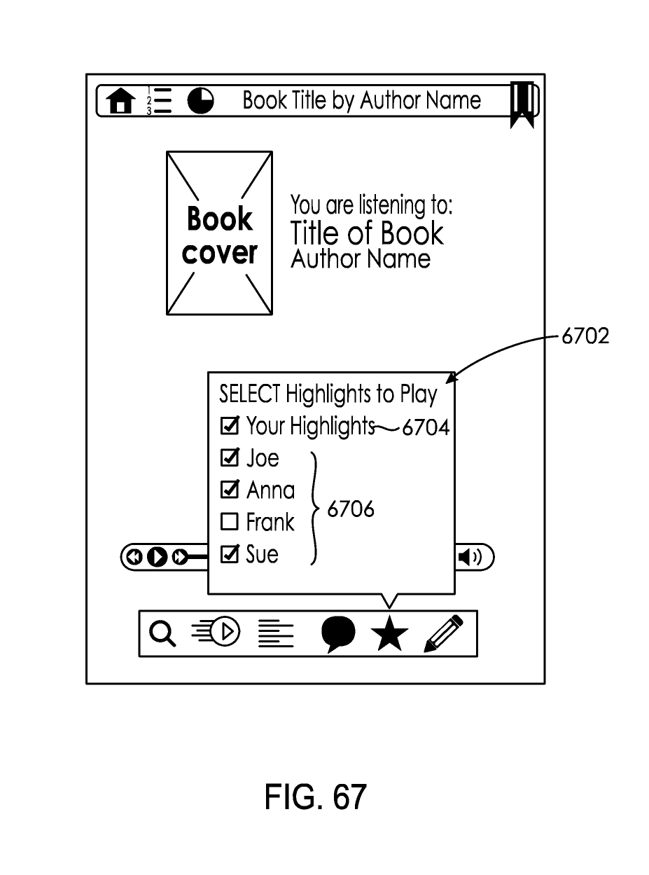

Regarding FIGS. 46 and 65-69, a user may alternatively select the start listening button 4614, as shown in FIG. 46. Upon selection, the eBook reading device 4102 enters an audio mode, as shown in FIG. 65, where the book cover content 4406, title information 4608, author information 4610, and chapter information 6502 are displayed. Similarly, the window 4304 may also include a header navigation bar 5302 as described above and a footer navigation bar 6504 which closely resembles the functionality and look of footer navigation bar 5314 in the reading mode described above. As such, the footer navigation bar 6504 may include the search icon 5316, the play audio icon 5318, the social commentary icon 5324, and the marker button icon 5326. In addition, footer navigation bar 6504 also include a switch to text icon 6506, which if selected, changes the display 4304 to a text only display (i.e., the text mode described above with reference to FIGS. 50-64) at the most recent audio point being played. Footer navigation bar 6504 also includes highlight icon 6508 which is described in reference FIG. 67.

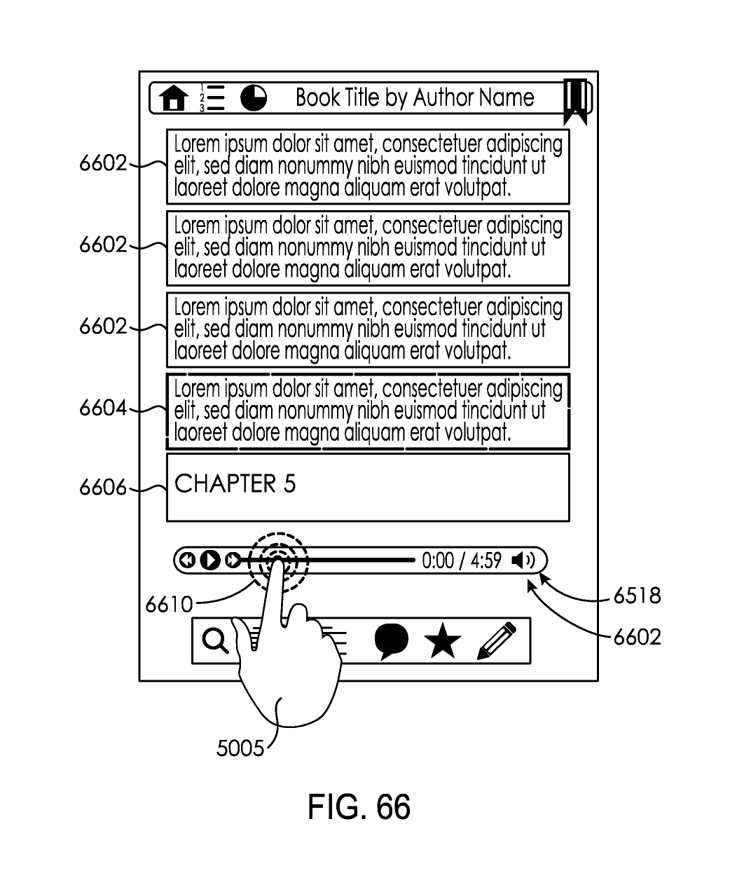

The window 4304 also includes an audio control panel 6518, which includes rewind icon 6512, play icon 6514, forward icon 6516, in addition to bar and slider icons 6004 and 6006, status data 6012, and volume control icon 6008. Using the audio control icons associated with panel 6518 such as the bar and slider 6004 and 6006, allows a user to scrub through the audio 224. As a user taps and selects 6610 the slider 6006, as illustrated in FIG. 66, text boxes 6602, 6604 appear on the display showing the text points near and at the time point associated with the slider 6006, respectively. The text at the time point associated with the slider 6006 is displayed in the center of the screen in center text box 6606. The text near the time point (e.g., immediately before) is displayed above the center of the screen in the top text box(s) 6602 and the text immediately after the time point is displayed below the center of the screen. Key navigation points such as chapters are displayed at single units 6606.

Referring to FIG. 65, selection of the highlight icon 6508 results in the display of highlight window 6702, as illustrated in FIG. 67, showing available highlights from the user of the device 6702 (e.g., via swiping as described above) and third parties 6706 associated with the user over a social network. After selection, the audio associated with the highlighted text may be played (e.g., as a tonal variation to the spoken text, wherein a low volume low frequency tone is played along with the spoken text).

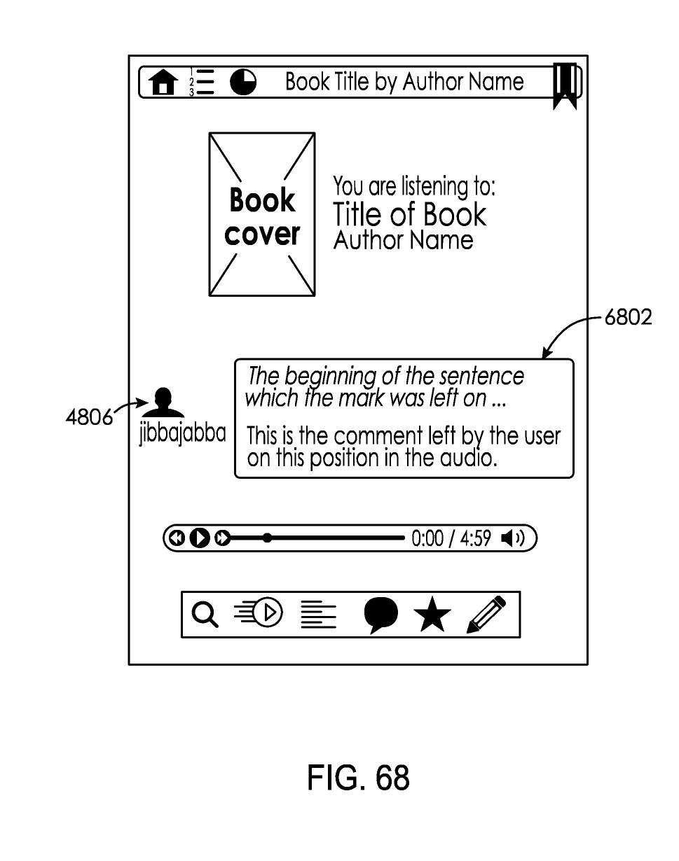

Audio-based social markers may be played in response to selection of the social commentary icon 5324. After selection of the source of the social marker (e.g., from the user or a third party), the audio-based social marker (e.g., comment) may be played (see FIG. 68) alongside the display of a textual window 6802 of the associated eBook text data corresponding to the marker. A textual window of the comment may also be displayed as shown in 6802.

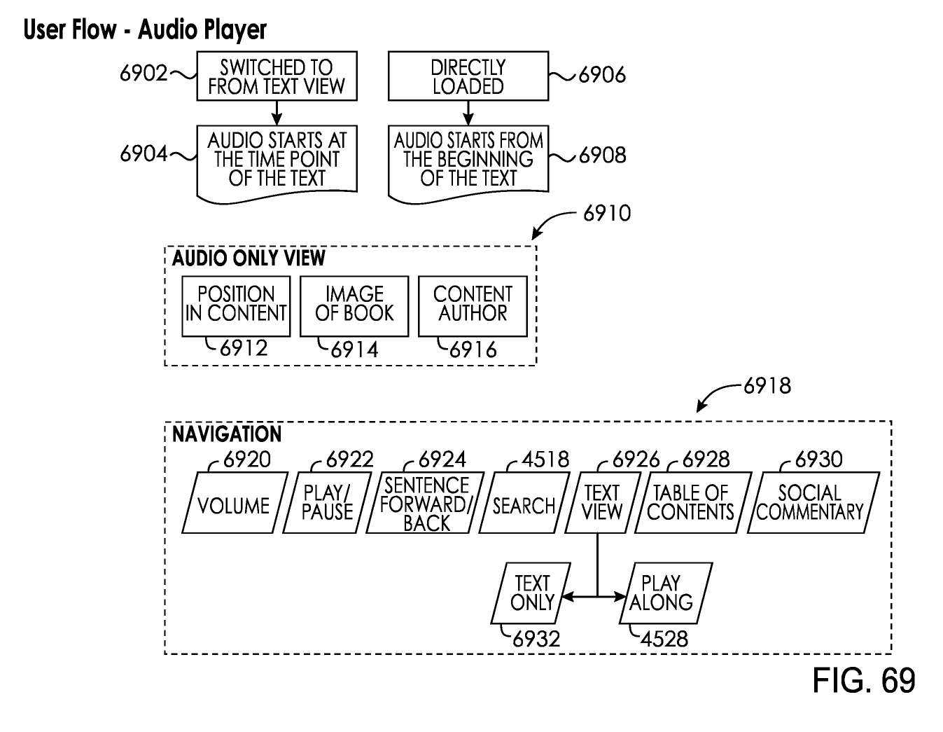

FIG. 69 describes a couple flows of the audio player depending on actions of the user. For example, one flow begins at block 6902 where in response to the user switching from text view to an audio mode, the reader may begin the audio playback at the same time point of where the user left off at block 6904. On the other hand, if the user directly loads the eBook into the reader at block 6906, then the reader may begin the audio at the beginning of the text for the user at block 6908.

FIG. 69 additionally illustrates an audio only view layout 6910 as presented on a navigation bar 5302 and an navigation layout 6918 as presented on an navigation bar 6504, such as shown for example in FIG. 65. In reference to FIG. 69, the audio only view layout 6910 may include a position in content module 6912, an image of book module 6914, and a content author module 6916. Additionally, the navigation layout 6918 includes a volume module 6920, a play/pause module 6922, a sentence forward or backward module 6924, a search module 4518, a text view module 6926, a table of contents module 6928, and a social commentary module 6930. Moreover, the navigation layout 6918 may include an text only module 6932 and a play along module 4528 that may be invoked in response to the text view module 6926 being selected.

Among other advantages, the above method and apparatus enables a new and improved time synchronized talking eBook generation logic capable of generating time synchronized talking eBooks and a new and improved reading device capable of providing the user experience associated with the time synchronized talking eBooks. In particular, the above disclosure combines the benefits of an audiobook with those of an eBook by using graphical-based markers instead of audio-based markers and using auto synchronization software to accurately and much more quickly synchronize the text to the audio recording (e.g., down to the word or components of a word level). By using graphical based markers, the laborious process of generating a conventional audiobooks is avoided. And, together with the time-synchronized audio and text, the graphical based markers provide precise navigational control of a talking eBook and eBook reading device required for a seamless reading and/or listening experience, enjoyable to both visually impaired and non-visually-impaired individuals. The above description provides mere examples of the various improvements described herein. Other embodiments are envisioned and covered by the appended claims. For example, the present disclosure provides an improved environment for hearing-impaired individuals and for students (e.g., students of foreign languages). It is therefore contemplated that the present disclosure covers any and all modifications, variations, or equivalents that fall within the spirit and scope of the basic underlying principles disclosed above and claimed herein.

As used herein, the following terms have the meanings described thereto as set forth below. “Logic” may refer to any single or collection of circuit(s), integrated circuit(s), processor(s), processing device(s), transistor(s), memory(s), combination logic circuit(s), or any combination of the above that is capable of providing a desired operation(s) or function(s). For example, “logic” may take the form of a processor executing instructions from memory, or a dedicated integrated circuit. “Memory” may refer to any suitable internal or external volatile or non-volatile, memory device, memory chip(s), or storage device or chip(s) such as, but not limited to system memory, frame buffer memory, flash memory, random access memory (RAM), read only memory (ROM), a register, a latch, or any combination of the above.

A “processor” may refer to one or more dedicated or non-dedicated: micro-processors, micro-controllers, sequencers, micro-sequencers, digital signal processors, processing engines, hardware accelerators, applications specific circuits (ASICs), state machines, programmable logic arrays, any integrated circuit(s), discreet circuit(s), etc. that is/are capable of processing data or information, or any suitable combination(s) thereof. A “processing device” may refer to any number of physical devices that is/are capable of processing (e.g., performing a variety of operations on) information (e.g., information in the form of binary data or carried/represented by any suitable media signal, etc.). For example, a processing device may be a processor capable of executing executable instructions, a desktop computer, a laptop computer, a mobile device, a hand-held device, a server (e.g., a file server, a web server, a program server, or any other server), any other computer, etc. or any combination of the above. An example of a processing device may be a device that includes one or more integrated circuits comprising transistors that are programmed or configured to perform a particular task.

“Executable instructions” may refer to software, firmware, programs, instructions or any other suitable instructions or commands capable of being processed by a suitable processor. A “communication link” may refer to any media through which signals, data, or any other information may be communicated. For example, communication link may include one or more wires, buses, cables, infrared signals, waveforms (e.g., a wireless path), network routers, hubs, etc. and any combination of the above. A “display device” may refer to any device or component of a device that is capable of visually reproducing visual information or data such as, but not limited to, a CRT, a LCD, LED, or plasma display device. One of ordinary skill in the art will recognize that a “display device” may include a combined input/output device such as a stylus and associated display. An “input device” may a include one or more devices such as a keyboard, mouse, track pad, stylus and associates display, or any other device or devices capable of permitting a user to provide input commands to logic. One of skill in the art will appreciate that an input device may include an input/output device.

What is claimed:

1. A computer-implemented method for generating a time-synchronized, talking electronic book (eBook), the method comprising:
generating, using the computer, eBook text data for a work of authorship based on searchable digital text of the work and marker data, wherein the marker data identifies at least a characteristic of the work;
generating, using the computer, synchronized text-to-audio metadata based on the eBook text data and an audio narration recording of the work, wherein the synchronized text-to-audio metadata associates a plurality of components of the eBook text data with the time the components are present in the audio narration recording; and
generating, using the computer, navigation control data based on synchronized text-to-audio metadata and bibliographic metadata associated with the work, wherein the navigation control data is capable of being used by an eBook reading device for navigational control of the display of eBook text data and playing of the audio narration recording.

2. The computer-implemented method of claim 1, wherein the navigation control data associates eBook text data with the audio narration recording on a sentence level.

3. The computer-implemented method of claim 1, further comprising generating, using the computer, time-stamped text data for the work based on the audio narration recording of the work, wherein the time-stamped text data includes a transcription of the audio narration recording of the work along with a time in which a plurality of components of the transcription are present in the audio narration recording, and wherein the synchronized text-to-audio metadata is based on the eBook text data and the time-stamped text data.

4. The computer-implemented method of claim 1, wherein the marker data identifies within the searchable digital text one or more of: acknowledgments, act, activity, address, afterword, alphabetical division, annotation, appendices, appendix, article, author's note, biographical notes, biography, bibliography, book, captions, cast of characters, chapter, chronology, closing announcements, conclusion, contents, day, discography, dramatis personae, entry, epilogue, essay, exercise, fable, family tree, filmography, foreword, further reading, genealogy, glossary, illustrations, index, ingredients, introduction, lesson, letter, maps, materials, month notes, novelette, novella, part, photographs, poem, postscript, prayer, preface, prelude, project, prologue, proverb, psalm, questions, questions and answers, recipe, recommended reading, references, resources, scene, section, selected references, sources, song, sonnet, speech, stanza, steps, story, subsection, suggested reading, summary, supplement, supplies, synopsis, table of contents, tale, testament, time line, title/author, unit, verse, vocabulary, volume, week, and year.

5. The computer-implemented method of claim 1, further comprising generating, using the computer, the searchable digital text from a tangible copy of the work of authorship.

6. The computer-implemented method of claim 1, wherein the audio narration recording of the work is based on the searchable digital text.

7. The computer-implemented method of claim 6, wherein the audio narration recording of the work is further based on bibliographic metadata associated with the work.

8. The computer-implemented method of claim 7, wherein the bibliographic metadata is associated with one or more of: a title of the work; a creator of the work; a subject of the work; a description of the work; a publisher of the work; a date of the work; a format of the work; an identifier of the work; a source of the work; a language of the work; instructions for narrating the work; and information identifying a characteristic of the audio narration recording.

9. The computer-implemented method of claim 1, wherein the time-stamped text data is a transcription of the audio narration recording with each word within the transcription being associated with a time each word is present within the audio narration recording.

10. A computer readable media having executable instructions stored thereon for generating a time-synchronized, talking electronic book (eBook), such that when executed by a processor, the instructions carry out a method comprising:
generating eBook text data for a work of authorship based on searchable digital text of the work and marker data, wherein the marker data identifies a characteristic of the work;
generating synchronized text-to-audio metadata based on the eBook text data and an audio narration recording of the work wherein the synchronized text-to-audio metadata associates a plurality of components of the eBook text data with the time the components are present in the audio narration recording; and
generating navigation control data based on synchronized text-to-audio metadata and bibliographic metadata associated with the work, wherein the navigation control data is capable of being used by an eBook reading device for navigational control of the display of eBook text data and playing of the audio narration recording.

11. The computer readable media of claim 10, wherein the navigation control data associates eBook text data with the audio narration recording on a sentence level.

12. The computer readable media of claim 10, wherein the method further comprises generating time-stamped text data for the work based on the audio narration recording of the work, wherein the time-stamped text data includes a transcription of the audio narration recording of the work along with a time in which a plurality of components of the transcription are present in the audio narration recording, and wherein the synchronized text-to-audio metadata is based on the eBook text data and the time-stamped text data.

13. The computer readable media of claim 10, wherein the method further comprises generating the searchable digital text from a tangible copy of the work of authorship.

14. The computer readable media of claim 10, wherein the audio narration recording of the work is based on the searchable digital text.

15. The computer readable media of claim 14, wherein the audio narration recording of the work is further based on bibliographic metadata associated with the work.

16. The computer readable media of claim 15, wherein the bibliographic metadata is associated with one or more of: a title of the work; a creator of the work; a subject of the work; a description of the work; a publisher of the work; a date of the work; a format of the work; an identifier of the work; a source of the work; a language of the work; instructions for narrating the work; and information identifying a characteristic of the audio narration recording.

17. The computer readable media of claim 10, wherein the time-stamped text data is a transcription of the audio narration recording with each word within the transcription being associated with a time each word is present within the audio narration recording.

18. A time-synchronized, talking electronic book (eBook) generation apparatus comprising:
markation logic operable to generate electronic book (“eBook”) text data for a work of authorship based on searchable digital text of the work and marker data, wherein the marker data identifies a characteristic of the work;
text-to-audio association logic operable to generate synchronized text-to-audio metadata based on the eBook text data and an audio narration recording of the work wherein the synchronized text-to-audio metadata associates a plurality of components of the eBook text data with the time the components are present in the audio narration recording; and
navigation control generation logic operable to generate navigation control data based on synchronized text-to-audio metadata and bibliographic metadata associated with the work, wherein the navigation control data is capable of being used by an eBook reading device for navigational control of the display of eBook text data and playing of the audio narration recording.

19. The apparatus of claim 18, further comprising demarcation speech-to-text converter logic operable to generate time-stamped text data for the work based on the audio narration recording of the work, wherein the time-stamped text data includes a transcription of the audio narration recording of the work along with a time in which a plurality of components of the transcription are present in the audio narration recording, and wherein the synchronized text-to-audio metadata is based on the eBook text data and the time-stamped text data.

20. The apparatus of claim 18, further comprising:
digital scanner logic operable to generate a digital copy of the work based on a tangible copy of the work; and
OCR converter logic operable to generate the searchable digital text from the digital copy of the work.
